(19) United States
(12) Patent Application Publication
(10) Pub. No.: US 2024/0380195 A1
(43) Pub. Date: Nov. 14, 2024

(54) CABLE MANAGEMENT SYSTEMS

(71) Applicant: SHOALS TECHNOLOGIES GROUP, LLC, Portland, TN (US)

(72) Inventors: Paul E. Attea, Portland, TN (US); David L. Schardt, Portland, TN (US)

(21) Appl. No.: 18/659,855

(22) Filed: May 9, 2024

Related U.S. Application Data
(60) Provisional application No. 63/501,089, filed on May 9, 2023.

(51) Int. Cl. H02G 9/04

(52) U.S. Cl. CPC H02G 9/04

(57) ABSTRACT

A cable management system may include a first segment, a second segment, or a pivoting link. The first segment may define a first volume configured to receive a cable. The second segment may define a second volume configured to receive the cable. The pivoting link may be configured to couple to the first segment to prevent rotation of the first segment relative to the pivoting link. The pivoting link may also be configured to couple to the second segment to form an articulating joint configured to permit the second segment to rotate relative to the pivoting link.

### CROSS-REFERENCE TO RELATED APPLICATION

This patent application claims the benefit of and priority to U.S. Provisional App. No. 63/501,089 filed May 9, 2023, titled “CABLE MANAGEMENT SYSTEMS,” which is incorporated in the present disclosure by reference in its entirety.

### FIELD

Embodiments described in the present disclosure are related to cable management systems and, more particularly, articulating cable management systems and drive-over cable management systems.

### BACKGROUND

Unless otherwise indicated in the present disclosure, the materials described in the present disclosure are not prior art to the claims in the present application and are not admitted to be prior art by inclusion in this section.

Photovoltaic (PV) systems (e.g., solar power systems) or electric vehicle (EV) charger systems (generally referred to in the present disclosure as “power systems”) may include power sources (e.g., a solar panel array, a power platform, or a grid) that are electrically coupled to other components within the power systems via cables, wires, or both. Power systems have historically been deployed at haphazard or ad hoc locations due to deployment costs associated with installation of power system infrastructures.

A large portion of the deployment costs may be associated with temporal aspects of power system infrastructures. Example deployments costs may include power entry equipment, cables, skids, extensive civil work, and long cable runs and connectors. For example, to deploy a power system, an uneven installation surface may be graded, trenches may be dug to route the cables underground, and the trenches may be filled in to protect the cables from vehicular traffic or other traffic. Alternatively, the trenches may be covered using plates, such as metal plates, to protect the cables from vehicular traffic or other traffic. Grading the uneven installation surface or installing the plates may increase the deployment costs of the power system. Further, management of the cables may reduce risk of a ground-fault, downtime of the power system, exposure of the cables to environmental elements, or risk of fire. Accordingly, there is a need for improved power systems that manage cables in a manner that reduces the deployment costs while also protecting the cables.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments of the present disclosure address the problems with deploying a power system on an uneven installation surface. Disclosed embodiments address such issues by providing a cable management system (CMS) that is configured to contour to the uneven installation surface. Alternatively or additionally, disclosed embodiments of the CMS may permit vehicular traffic or other traffic to traverse the CMS. The CMS may permit the power system to be deployed on the uneven installation surfaces without grading the uneven installation surface, digging trenches, or both while protecting the cables from exposure factors.

In an example embodiment, the CMS may include an articulating CMS that includes a first segment, a second segment, or a pivoting link. The first segment may define a first volume. The second segment may define a second volume. The pivoting link may couple the first segment and the second segment together to form one or more articulating joints. The articulating joints may permit the first segment, the second segment, or both to rotate relative to the pivoting link to permit the CMS to contour to the uneven installation surface.

In an example embodiment, the CMS may include a drive-over CMS that includes a cover and a baseplate that are configured to be load bearing to permit vehicles or other transportation devices to travel over the drive-over CMS or to otherwise support transitory loads passing over the drive-over CMS or permanent or semi-permanent loads on the drive-over CMS. The cover may include ramp portions that are coupled to each other via a top wall. The drive-over CMS may permit the vehicles or other transportation devices to drive up a ramp portion along the top wall and down another ramp portion.

Accordingly, in some embodiments, the power system may be deployed without having to grade the uneven installation surface or to dig trenches to run the cables. Alternatively or additionally, the cables may be protected from vehicular traffic, other traffic or loads, or other exposure factors while being routed above-ground. Alternatively or additionally, the cable may generally contour to the uneven installation surface. In some embodiments, after installation, the drive-over CMS, the articulating CMS, or both may be partially disassembled to service the cable, which may permit easier servicing than if the cable is buried in a trench.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a perspective view of an example EV charger system;

FIG. 2 illustrates an operational diagram of an example PV system;

FIGS. 3A-3C illustrate a perspective view, a side view, and an overhead partial view of a portion of the CMS of FIGS. 1 and 2;

FIGS. 4A-4C illustrate an exploded front view, a side perspective view, and a bottom perspective view of an example segment of the CMS of FIGS. 3A-3C;

FIGS. 5A and 5B illustrate side views of a portion of the CMS of FIGS. 1 and 2 in different installed positions;

FIG. 6 illustrates an example pivoting link that may be implemented in the CMS of FIGS. 1 and 2;

FIGS. 7A and 7B illustrate perspective views of an example cover and of other components of the CMS of FIGS. 1 and 2;

FIGS. 8A and 8B illustrate perspective views of an example multicable clip;

FIG. 8C illustrates a perspective view of one example of a pedestal of the multicable clip of FIGS. 7A and 7B;

FIG. 9 illustrates the example segment of FIGS. 4A-4C, including an anchor fastener;

FIGS. 10A-10C illustrate an exploded view, a side perspective view, and a bottom perspective view of another example CMS;

FIG. 11 illustrates an overhead view of a portion of a baseplate of the CMS of FIGS. 10A-10C;

FIGS. 12A-12C illustrate a perspective view, a side view, and an overhead partial view of an example CMS;

FIGS. 13A-13D illustrate a front view, a partially exploded side perspective view, a partially exploded bottom perspective view, and a perspective view of components of an example segment of the CMS of FIGS. 12A-12C;

FIGS. 14A-14D illustrate a front view, a partially exploded side perspective view, a partially exploded bottom perspective view, and a perspective view of components of an example segment that includes two channel portions and a middle channel portion;

FIGS. 15A and 15B illustrate a perspective view of a body of an example pivoting link and a perspective view of the example pivoting link that may be implemented in the CMS of FIGS. 12A-12C; and

FIG. 16 illustrates the example segment of FIGS. 13A-13D including anchor fasteners;

all arranged in accordance with at least one embodiment described in the present disclosure.

### DESCRIPTION OF EMBODIMENTS

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

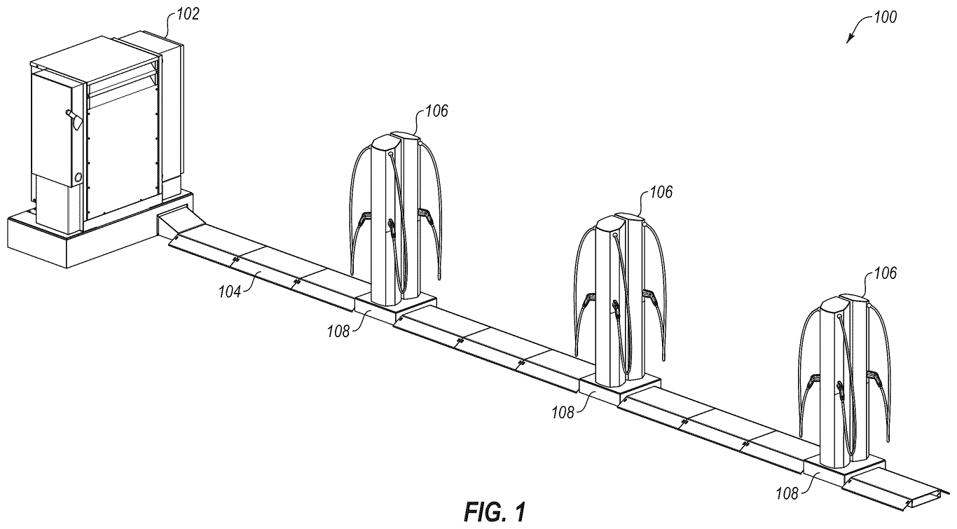

FIG. 1 illustrates a perspective view of an example EV charger system 100 (hereinafter system 100). The system 100 may include a power platform 102, a CMS 104, cables or other wiring (not illustrated in FIG. 1), and one or more charger platforms 106 (generally referred to in the present disclosure as charger platforms 106).

In some embodiments, the system 100 may include multiple pairs of cables in which each pair electrically couples the power platform 102 to a different set of one or more charger platforms 106. Alternatively, or additionally, each pair of the cables may electrically couple the power platform 102 to a different set of one or more EV chargers. For example, one pair of the cables may electrically couple the power platform 102 to a first set of four EV chargers of a first charger platform 106, another pair of cables may electrically couple the power platform 102 to a second set of four EV chargers of a second charger platform 106, and so on.

In some embodiments, the cables may each include a feeder cable, one or more drop lines, one or more drop line connectors, or one or more in-line fuses. Alternatively or additionally, the cables may include one or more load side breakers or in-line fuses (e.g., electrically coupled between the feeder cable and the drop lines) to electrically protect the drop lines and the chargers. Each cable may transmit the power from the power platform 102 to the charger platforms 106 or return current from the charger platforms 106 to the power platform 102.

The power platform 102 may be coupled to a solar panel array, a power platform, a grid, or any other appropriate power source (not illustrated in FIG. 1). The power source may be electrically coupled to the power platform 102 via the cables. The power platform 102 may transform input power or otherwise condition the input power from the power source for compatibility with an EV, the charger platforms 106, or both. The power platform 102 may receive the input power and generate output power for operation of the charger platforms 106. For example, the power platform 102 may receive and transform the input power having a first current and voltage to the output power having a second current and voltage that is different from the first current and voltage.

In some embodiments, the system 100 may include a direct current (DC) powered system. For example, one of the cables may include a positive cable connected to a positive lead of each charger platform 106 and another of the cables may include a negative cable connected to a negative lead of each charger platform 106. In some embodiments, the system 100 may include an alternating current (AC) powered system. For example, the cables may be arranged to support single phase AC power (e.g., using a first cable and a second cable) or arranged to support three phase AC power (e.g., using a first cable, a second cable, a third cable, and a neutral line).

Instead of or in addition to transforming voltage, the power platform 102 may convert an AC input power to a DC output power, in which case the power platform 102 may include an AC-to-DC converter, or may convert DC power to AC power, in which case the power platform 102 may include a DC-to-AC converter. In some embodiments, the output power may include DC power to charge batteries, such as EV batteries. In some embodiments, the output power may include AC power provided to the charger platforms 106. In these embodiments, the charger platforms 106 may convert the AC power to DC power to charge the EV batteries.

The charger platforms 106 may be electrically coupled to the power platform 102 via the cables. The charger platforms 106 may each include a pedestal base 108 and one or more EV chargers. The pedestal bases 108 may engage the CMS 104 and the EV chargers. The pedestal bases 108 may permit the CMS 104 and the charger platforms 106 to be installed above-ground. In addition, the pedestal bases 108 may permit the CMS 104 to function as an above-ground wiring run.

Each of the charger platforms 106 may include one or more EV chargers. In some embodiments, the EV chargers may be electrically coupled to a vehicle or to any other device that may receive power from the system 100. The charger platforms 106 may convert the power received from the power platform 102 via the cables for compatibility with an EV. For example, the EV chargers may convert the power from an AC power signal to a DC power signal that is compatible with the EV.

In some embodiments, the CMS 104 may extend from the power platform 102 to the charger platforms 106 or between the charger platforms 106 on the same surface on which the power platform 102 is installed or located. For example, the CMS 104 may extend along an installation surface on which the power platform 102 is located, and from the power platform 102 to the charger platforms 106. Alternatively, or additionally, the CMS 104 may include corners, bends, curves, etc., in extending between the power platform 102 and the charger platforms 106 or between charger platforms 106.

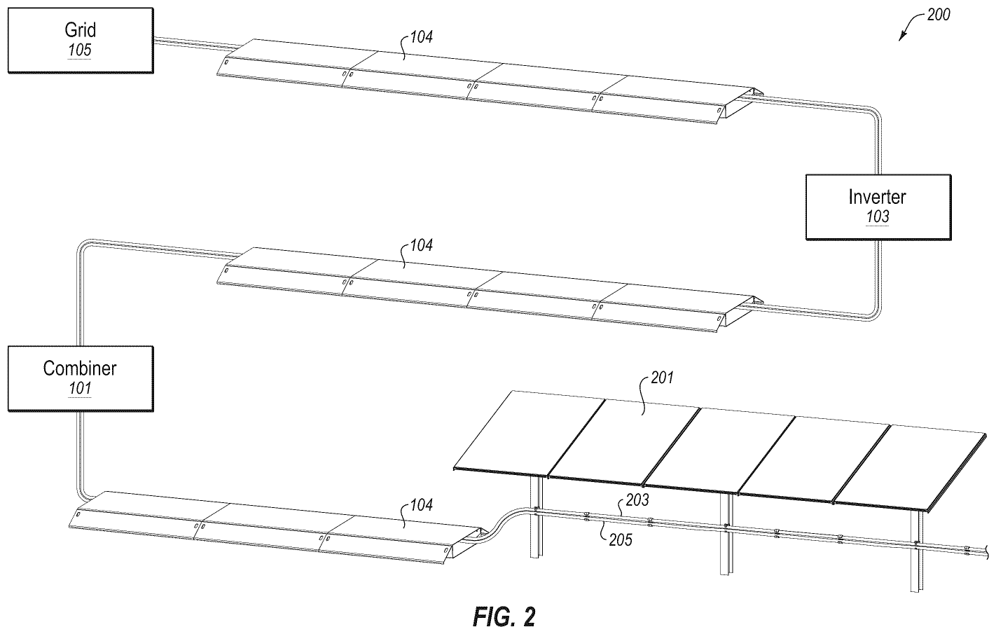

FIG. 2 illustrates an operational diagram of an example PV system 200. The PV system 200 may include a solar panel array 201 electrically coupled to a combiner 101 via a first cable 203, a second cable 205, or both. The solar panel array 201, the combiner 101, or the inverter 103 is/are one example of a power source to which the power platform 102 may be coupled. The first cable 203 or the second cable 205 may include drop lines (not illustrated in FIG. 2) electrically coupled to different solar panels of the solar panel array 201. The drop lines may electrically couple the first cable 203 or the second cable 205 to the different solar panels of the solar panel array 201. The PV system 200 may also include an inverter 103 electrically coupled to the combiner 101 and a grid 105. In addition, the PV system 200 may include the CMS 104 to house the first cable 203 and the second cable 205.

The solar panel array 201 may harvest a flow of energy (e.g., solar radiation) and generate an electrical power signal, which may be passed to the combiner 101 via the first cable 203, the second cable 205, or both. The combiner 101 may combine the power signal received via the first cable 203 and the second cable 205 to generate a combined power signal. The combiner 101 may provide the combined power signal to the inverter 103. The inverter 103 may convert the combined power signal from a DC power signal to an AC power signal to generate an inverted power signal that is compatible with the grid 105. The inverter 103 may provide the inverted power signal to the grid 105.

The CMS 104 may extend between the solar panel array 201 and the combiner 101, the combiner 101 and the inverter 103, the inverter 103 and the grid 105, or some combination thereof. In some embodiments, the CMS 104 may extend from the solar panel array 201 to the combiner 101, the combiner 101 to the inverter 103, the inverter 103 to the grid 105, or some combination thereof on the same installation surface on which the combiner 101, the inverter 103, the grid 105, or some combination thereof is installed or located.

With combined reference to FIGS. 1 and 2, the CMS 104 may house and secure at least a portion of the cables, such as the cables 203 and 205, to protect them from vehicular traffic, other traffic or loads, or other exposure factors. In addition, the CMS 104 may permit vehicles or other transportation devices to traverse the CMS 104.

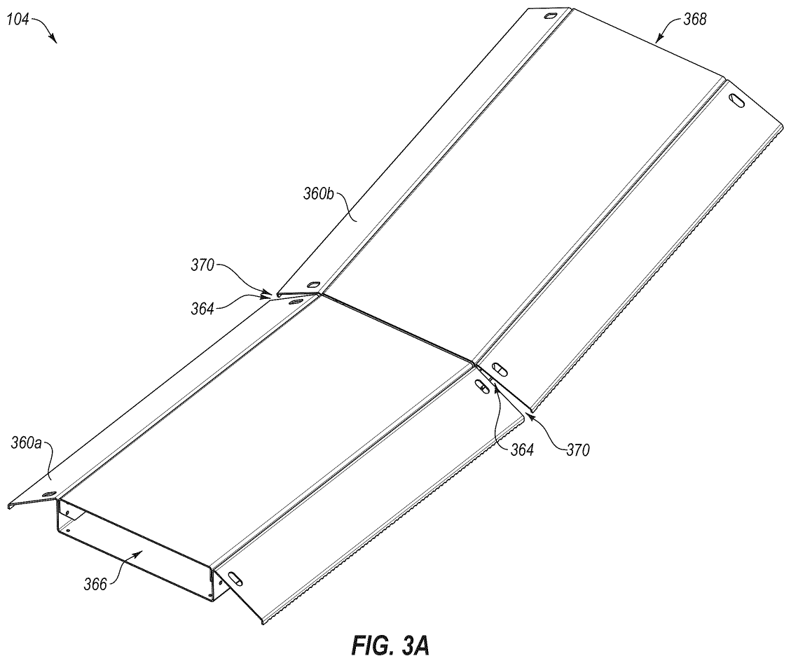

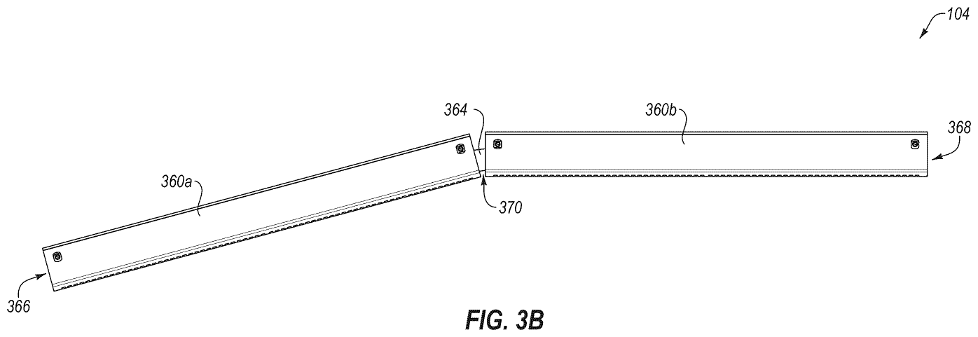

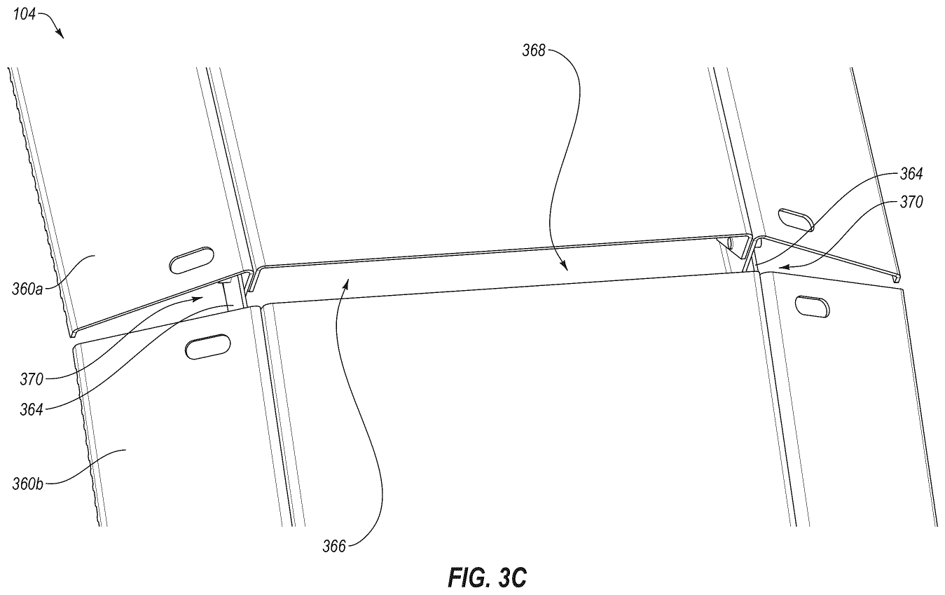

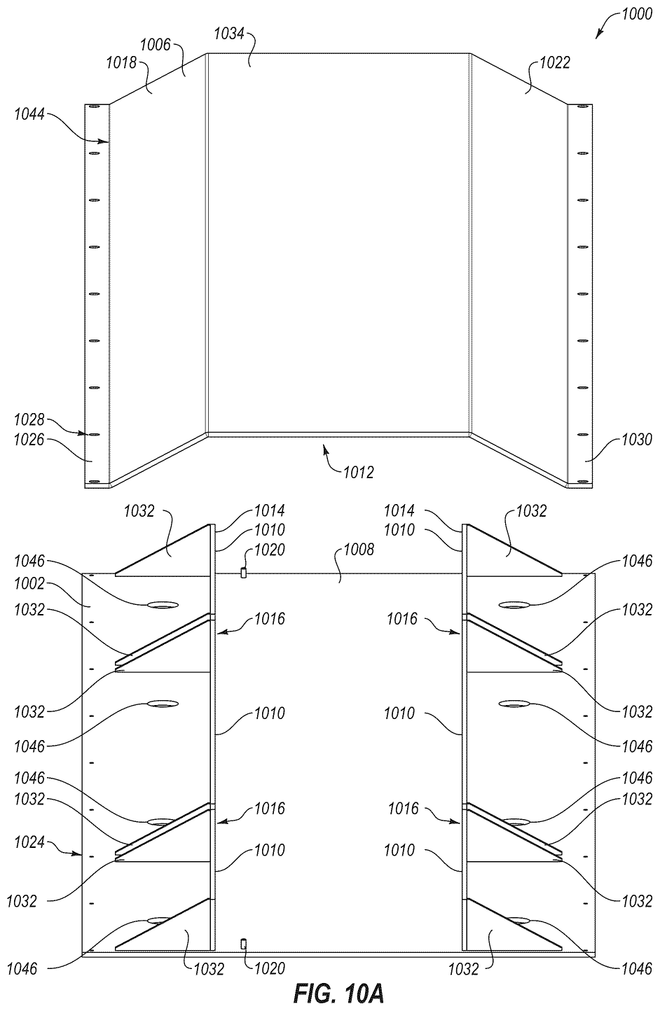

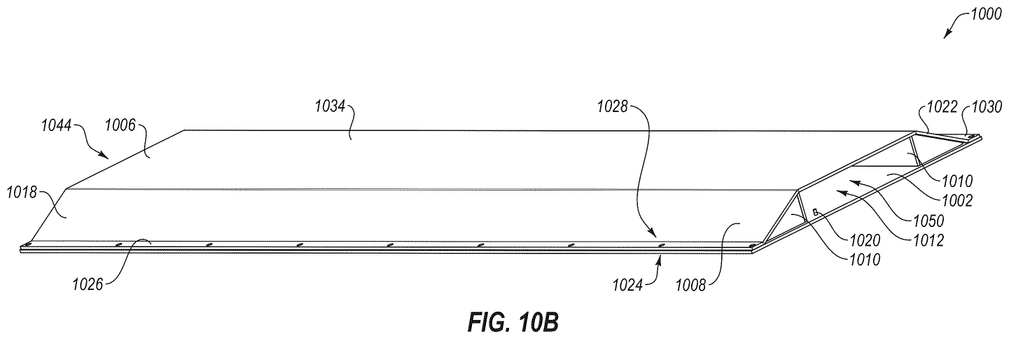

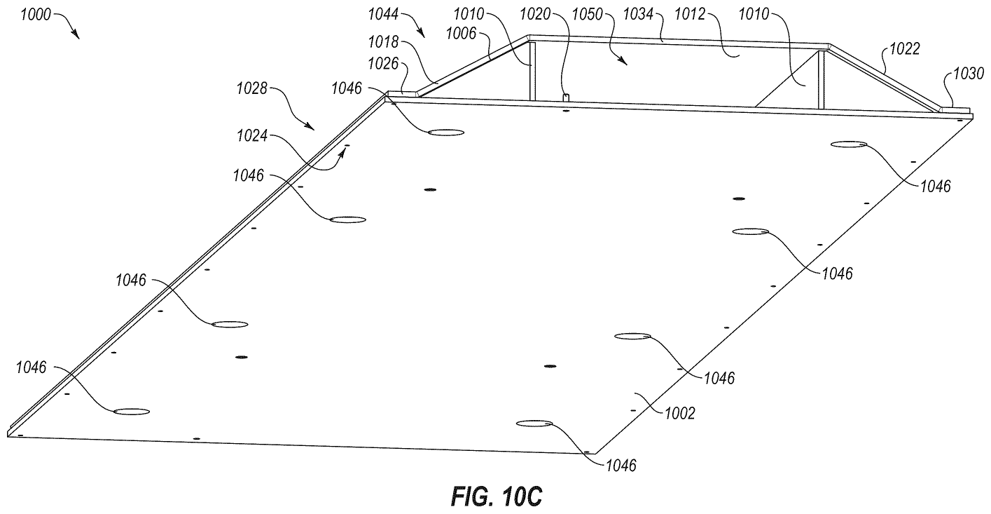

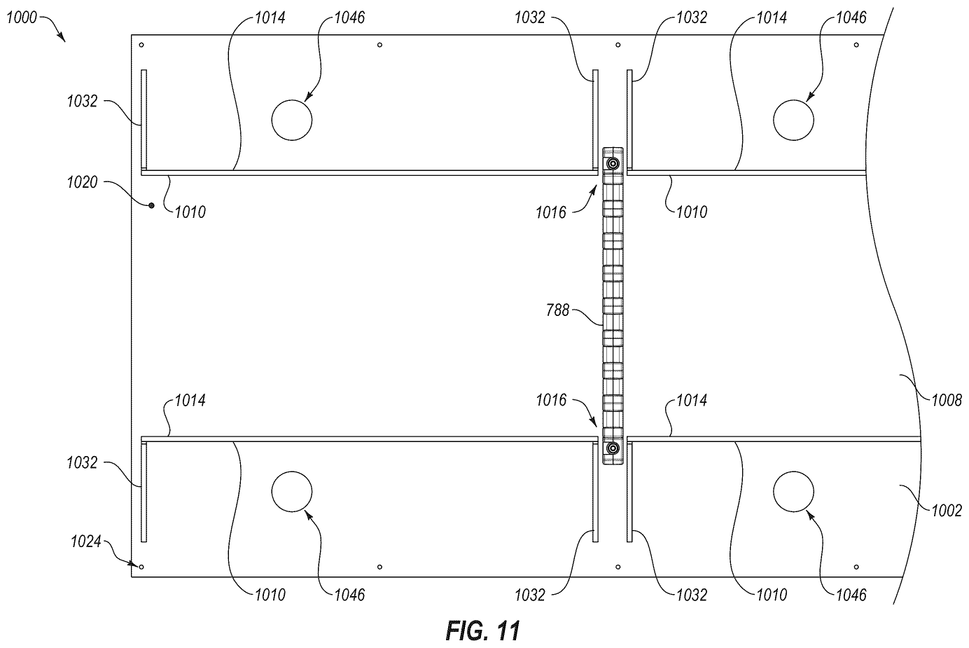

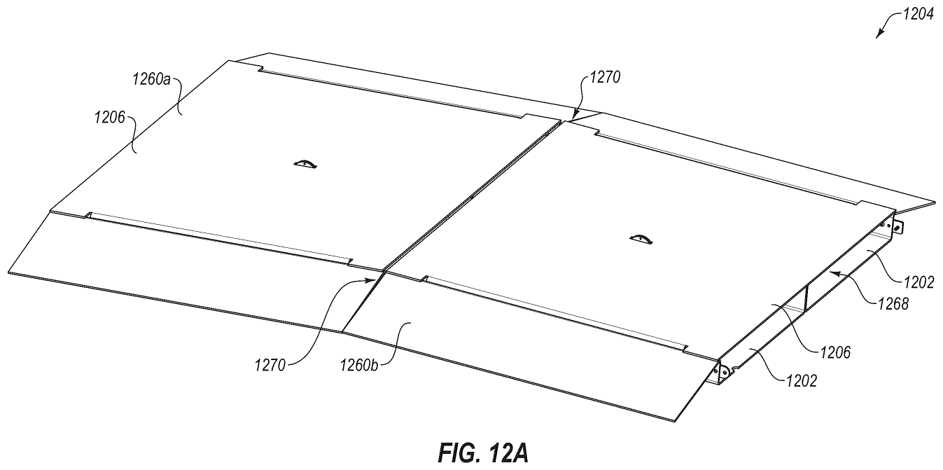

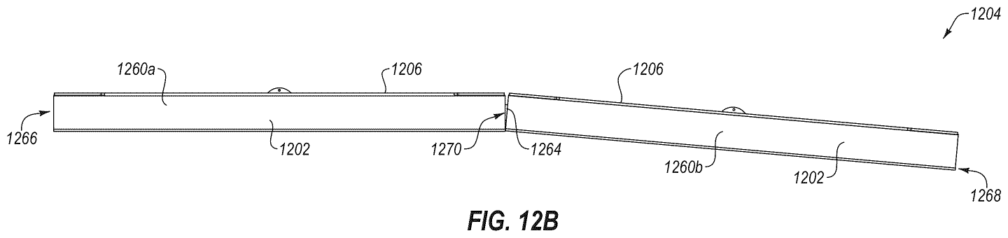

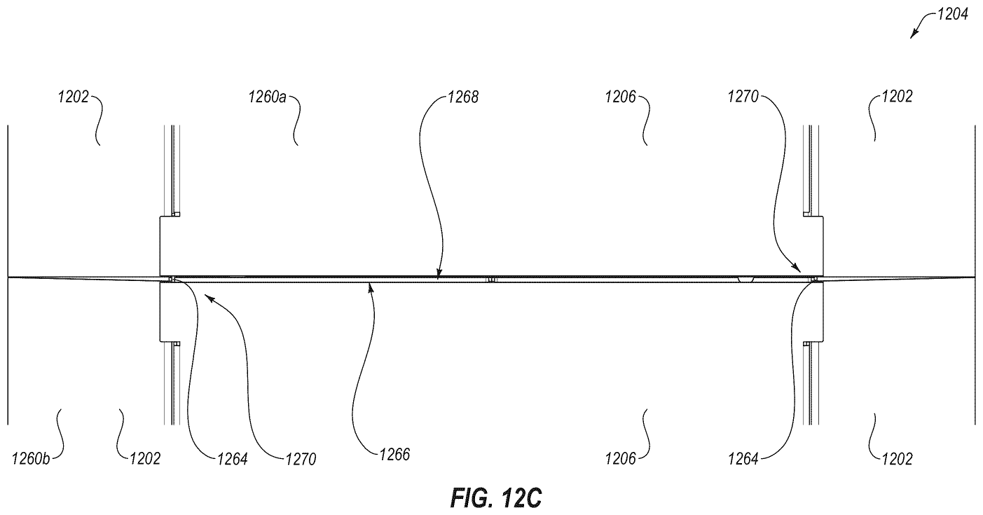

In some embodiments, the CMS 104 may include an articulating CMS and, although illustrated in FIGS. 1 and 2 as being routed on an even installation surface, the CMS 104 may be configured to articulate to conform to an uneven installation surface. An example of the CMS 104 as an articulating CMS is discussed below in relation to FIGS. 3A-3C. Additionally or alternatively, an example articulating CMS 1204 is discussed below in relation to FIGS. 12A-12C. In other embodiments, the CMS 104 may include a drive-over CMS. An example of the CMS 104 as a drive-over CMS is discussed in more detail below in relation to FIGS. 10A-11.

The CMS 104 may eliminate the need for grading or trenching of the installation surface as required in other power systems. The CMS 104 may also permit the cables, such as cables 203 and 205, to be installed above-ground and protected within the CMS 104.

FIGS. 3A-3C illustrate a perspective view, a side view, and an overhead partial view of a portion of the CMS 104 of FIGS. 1 and 2. In the example illustrated in FIGS. 3A-3C, the CMS 104 may include an articulating CMS that includes a series of segments 360a and 360b (generally referred to in the present disclosure as segments 360). For example, the CMS 104 may include a first segment 360a and a second segment 360b. The CMS 104 is illustrated in FIGS. 3A-3C as including two segments 360 for simplicity. More generally, the CMS 104 may include any appropriate number of segments. For example, the CMS 104 may include two, three, four, five, or more segments 360. In some embodiments, more segments 360 may be added to the CMS 104 to increase a length of the CMS 104. In these and other embodiments, the segments 360 may be removed from or added to the CMS 104 to alter the length of the CMS 104. The first segment 360a may define a first volume 366. In addition, the second segment 360b may define a second volume 368.

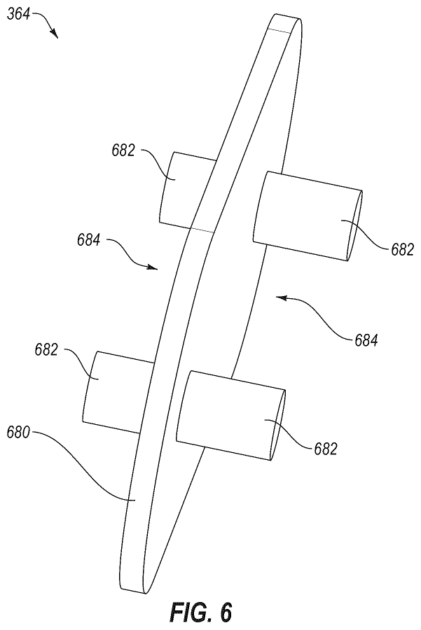

The CMS 104 may include pivoting links 364. The pivoting links 364 may couple the first segment 360a and the second segment 360b together to permit the first segment 360a, the second segment 360b, or both to rotate (e.g., pivot) around portions (e.g., pins such as denoted 682 in FIG. 6) of the pivoting links 364. In some embodiments, the pivoting links 364 may engage only a baseplate of the first segment 360a and a baseplate of the second segment 360b. In other embodiments, the pivoting links 364 may engage the baseplate and a cover of the first segment 360a and the baseplate and a cover of the second segment 360b. In some embodiments, the CMS 104 may include two pivoting links 364 per coupling (e.g., seam) between the segments 360. In other embodiments, the CMS 104 may include one pivoting link 364 per coupling (e.g., seam) between the segments 360. An example of the pivoting links 364 is discussed in detail below in relation to FIG. 6.

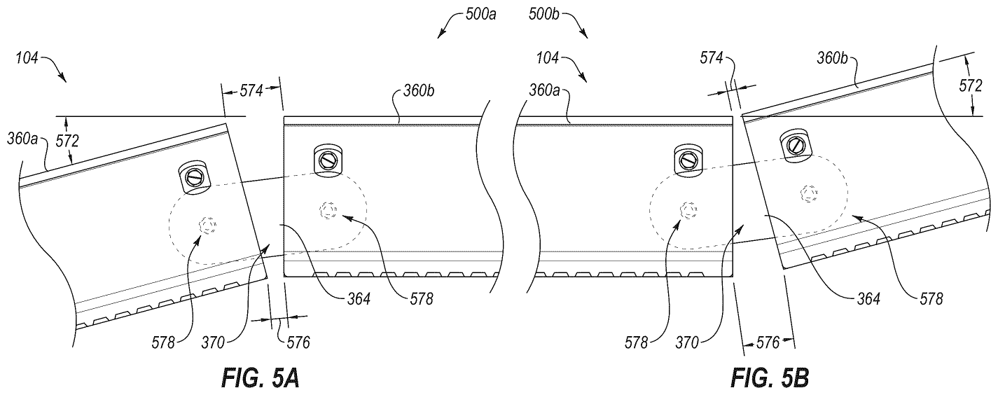

The engagement between the pivoting links 364 and the segments 360 may form articulating joints 370. The articulating joints 370 may each form or include multiple articulating points. Example articulating points 578 are discussed in more detail below in relation to FIG. 5.

The articulating joints 370 may permit the first segment 360a, the second segment 360b, or both to rotate relative to the pivoting links 364. For example, the articulating joints 370 may permit the first segment 360a, the second segment 360b, or both to articulate in the vertical direction. In addition, the articulating joints 370 may permit the CMS 104 to contour to the installation surface, which may permit the first volume 366 and the second volume 368 to route a cable that also contours to the installation surface. The CMS 104 may contour (e.g., conform) to the installation surface by articulating in the vertical direction while maintaining contact with at least a portion of the installation surface.

In some embodiments, the segments 360 (e.g., adjacent segments) may be electrically coupled to each other to ground the entire CMS 104. For example, the CMS 104 may include ground studs (not illustrated in FIGS. 3A-3C) electrically coupled to the segments 360. The ground studs may electrically ground the CMS 104.

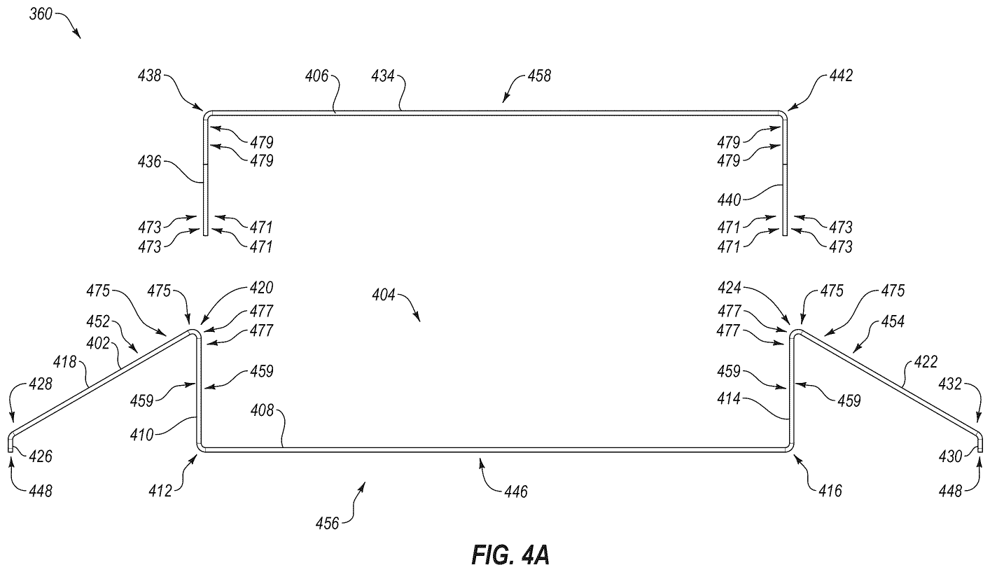

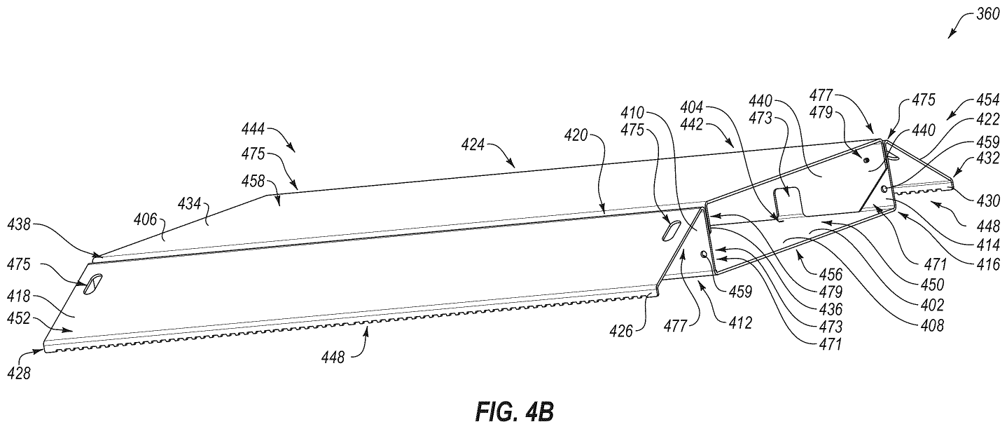

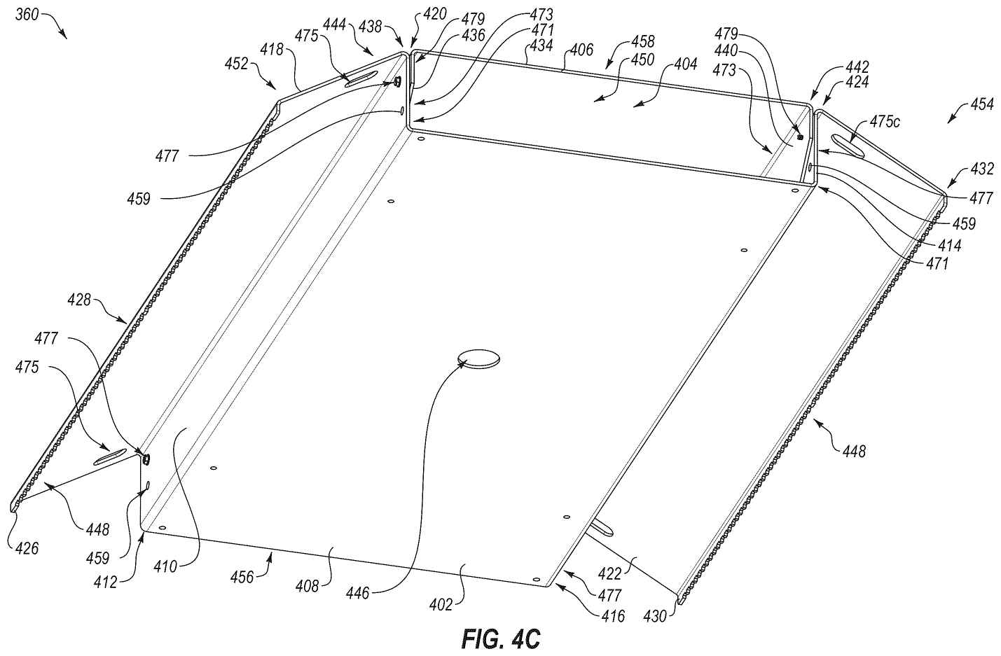

FIGS. 4A-4C illustrate an exploded front view, a side perspective view, and a bottom perspective view of an example segment 360 of the CMS 104 of FIGS. 3A-3C. The segment 360 may correspond to the first segment 360a or the second segment 360b.

The segment 360 may include a baseplate 402 and a cover 406. The cover 406 may engage the baseplate 402. For example, the cover 406 may engage the baseplate 402 within at least a portion of an opening 404 defined by the baseplate 402. As another example, the cover 406 may slide into the opening 404. The baseplate 402 and the cover 406 may define a volume 450 (illustrated in FIGS. 4B and 4C). The volume 450 may correspond to the first volume 366 or the second volume 368 of FIGS. 3A-3C.

The baseplate 402 and the cover 406 may include a top surface 444 (illustrated in FIGS. 4B and 4C). In addition, the baseplate 402 and the cover 406 may be load bearing to permit vehicular travel or other travel along or loads upon the top surface 444. For example, the segment 360 may permit an automobile, a truck, a vehicle, a human, or other transportation device to traverse or be supported by the top surface 444.

The baseplate 402 may include a base wall 408, a first sidewall 410, and a second sidewall 414. The first sidewall 410 may extend from a first edge 412 of the base wall 408. The second sidewall 414 may extend from a second edge 416 of the base wall 408. The second edge 416 may be positioned opposite the first edge 412. In some embodiments, the first sidewall 410 may be parallel to the second sidewall 414. The use of ordinals herein for similarly named elements, e.g., “first sidewall” and “second sidewall”, is intended merely to distinguish between similarly named elements and does not indicate or connote a particular order, precedence, priority, or the like, unless context dictates otherwise.

The first sidewall 410, the second sidewall 414, or both may define link openings 459. In some embodiments, the link openings 459 may be configured to interface with the pivoting links 364 (not illustrated in FIGS. 4A-4C). In these and other embodiments, the link openings 459 may be circularly shaped to mate with pins of the pivoting links 364 to prevent movement of the pivoting links 364 along a longitudinal axis of the first sidewall 410 and the second sidewall 414. Alternatively, the link openings 459 may be formed as horizontal channels (e.g., slotted channels) extending along the longitudinal axis of the first sidewall 410 and the second sidewall 414. The horizontal channels may extend a range of movement of the segment 360 relative to the pivoting links 364, an adjacent segment, or both. In some embodiments, the horizontal channels may permit adjustment of a gap between adjacent segments; for example, the gap between adjacent segments may be reduced or increased by sliding pins of the pivoting links 364 within the horizontal channels. The link openings 459 may be any appropriate shape that permits rotation of the segment 360 relative to the pivoting links 364. For example, the link openings 459 may include a rectangular shape, a square shape, a triangular shape, or any other appropriate shape.

The baseplate 402 may include a first ramp portion 418 and a second ramp portion 422. The first ramp portion 418 may extend diagonally from a third edge 420 of the first sidewall 410. In addition, the first ramp portion 418 may include a first top surface 452. The second ramp portion 422 may extend diagonally from a fourth edge 424 of the second sidewall 414. The second ramp portion 422 may include a second top surface 454. The baseplate 402 may include a recessed portion 456 coupled to the first ramp portion 418 and the second ramp portion 422. In some embodiments, the recessed portion 456 may define the opening 404. Alternatively or additionally, the recessed portion 456 may include or be formed by the base wall 408 and the first and second sidewalls 410, 414.

The baseplate 402 may include a first flange 426 and a second flange 430. The first flange 426 may extend from a fifth edge 428 of the first ramp portion 418. The second flange 430 may extend from a sixth edge 432 of the second ramp portion 422. In some embodiments, the first flange 426 may be parallel to the second flange 430. Alternatively, the first flange 426 or the second flange 430 may be omitted.

The cover 406 may include a top wall 434, a third sidewall 436, and a fourth sidewall 440. The top wall 434 may include a third top surface 458. The third sidewall 436 may extend from a seventh edge 438 of the top wall 434. The fourth sidewall 440 may extend from an eighth edge 442 of the top wall 434. The eighth edge 442 may be positioned opposite the seventh edge 438. In some embodiments, the third sidewall 436 may be parallel to the fourth sidewall 440. The cover 406 may engage the baseplate 402 within at least a portion of the opening 404 to position the third sidewall 436 proximate the first sidewall 410 and to position the fourth sidewall 440 proximate the second sidewall 414.

In some embodiments, the first ramp portion 418, the second ramp portion 422, or the cover 406 may permit a vehicle to traverse the first top surface 452, the second top surface 454, or the third top surface 458. In these and other embodiments, the top surface 444 may include a combination of the first top surface 452, the second top surface 454, or the third top surface 458.

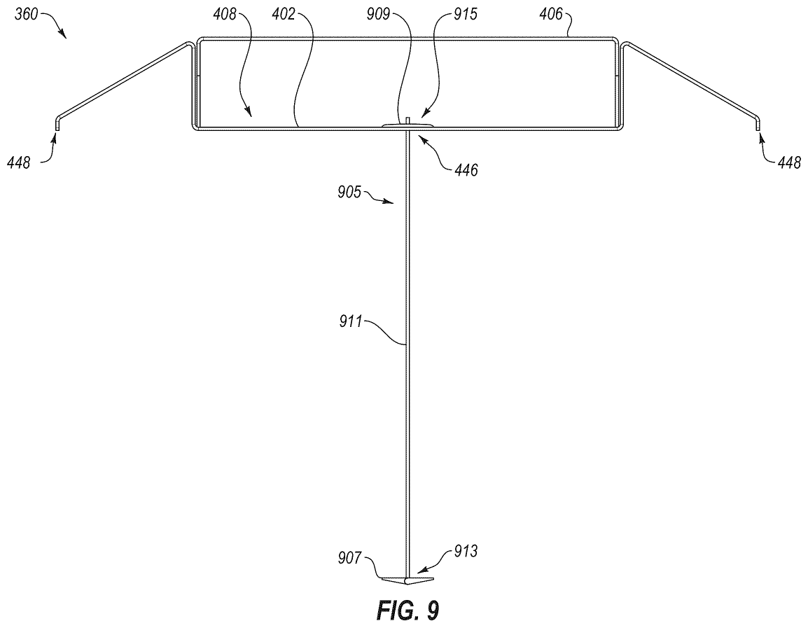

In some embodiments, the base wall 408 may define an anchor opening 446 (illustrated in FIGS. 4A and 4C). The anchor opening 446 may be configured to interface with an anchor fastener (not illustrated in FIGS. 4A-4C) to secure the segment 360 to the installation surface and prevent the segment 360 from moving relative to the installation surface. In some embodiments, the anchor fastener may include an earth screw. The base wall 408 is illustrated in FIGS. 4A and 4C as defining one anchor opening 446 as an example. More generally, the base wall 408 may define one or more anchor openings, such as one, two, three, or four anchor openings or even more anchor openings. An example anchor fastener 905 is discussed in more detail below in relation to FIG. 9.

The cover 406 may be removable from the segment 360, as illustrated in FIG. 4A, to provide access to the base wall 408 or the recessed portion 456. For example, removing the cover 406 may expose the base wall 408 to permit the anchor fastener to be installed or the cables to be routed through the opening 404 (e.g., the volume 450).

The segment 360, as shown in FIGS. 4A-4C, may include teeth 448. For example, the first flange 426 may include teeth 448 on an edge opposite the fifth edge 428. As another example, the second flange 430 may include teeth 448 on an edge opposite the sixth edge 432. The teeth 448 may interface with or engage the installation surface to prevent the segment 360 from moving relative to the installation surface, such as along a longitudinal axis of the segment 360, along a lateral axis of the segment 360, or more generally in any direction along the installation surface. In these and other embodiments, the teeth 448 may provide an additional anchor point for the segment 360 and the installation surface. Alternatively, the teeth 448 may be omitted and the first flange 426 and the second flange 430 may include a smooth edge surface.

In some embodiments, the baseplate 402 may define one or more attachment openings 477. In these and other embodiments, the cover 406 may define one or more cover attachment openings 479. The attachment openings 477 and the cover attachment openings 479 may be configured to align or interface with fasteners. For example, one or more of the attachment openings 477 may align to a corresponding one of the cover attachment openings 479 to receive fasteners therethrough. The fasteners may include, e.g., self-tapping screws, grounding screws, nuts and bolts, or other fasteners. The fasteners may prevent the cover 406 from moving relative to the baseplate 402 within the opening 404. In other words, the fasteners interfacing with the attachment openings 477, the cover attachment openings 479, or both may prevent movement of the cover 406 relative to the baseplate 402.

The fasteners may operate as grounding devices (e.g., grounding screws) in addition to attaching the cover 406 to the baseplate 402. In some embodiments, the fasteners may also attach grounding straps (e.g., conductive bonding whips) to the segment 360 to electrically couple or ground adjacent segments.

The first ramp portion 418 may define one or more ramp openings 475. Additionally, or alternatively, the second ramp portion 422 may define one or more ramp openings 475. The ramp openings 475 may be defined to be proximate to corresponding attachment openings 477. The ramp openings 475 may permit the fasteners to access the attachment openings 477 and for a driver (e.g., a screwdriver, a socket wrench, or any other appropriate driver) to attach the fasteners to or remove the fasteners from the attachment openings 477.

In some embodiments, the cover 406 may define one or more link cutouts 471. The link cutouts 471 may permit the pivoting links 364 to engage only the baseplate 402.

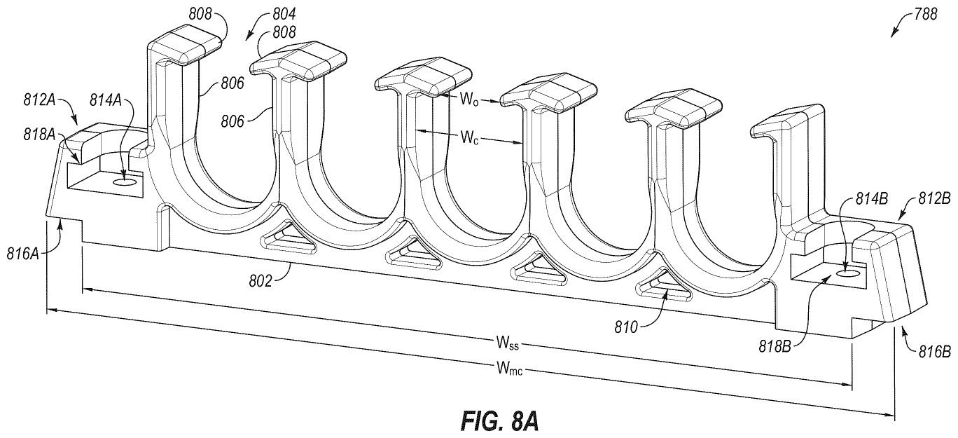

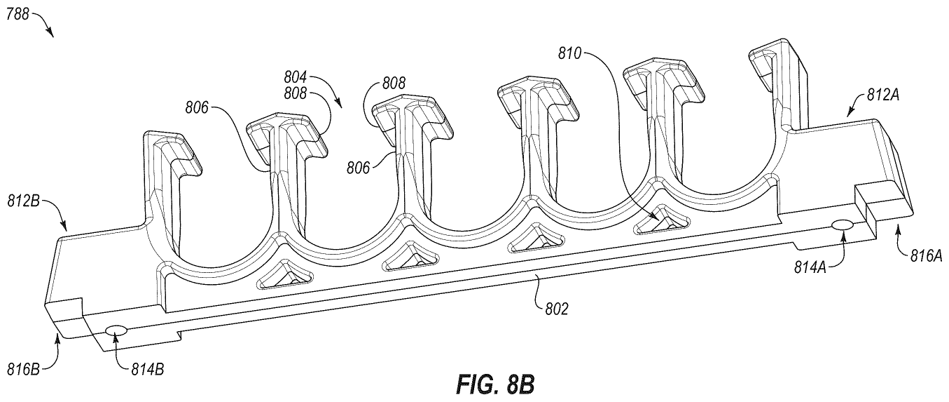

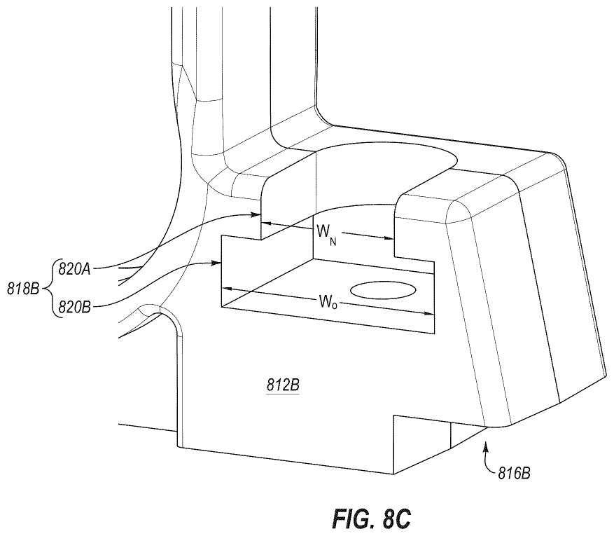

The cover 406 may define one or more clip openings 473. The cover 406 may engage at least one multicable clip along a length of the cover 406 via the clip openings 473. The clip openings 473 may engage the at least one multicable clip to enclose the multicable clip, a stacked retention assembly, the cables, or some combination thereof. For example, the clip openings 473 may engage shoulders or other structure of the multicable clip. An example multicable clip 788 is discussed in more detail below in relation to FIGS. 8A-8C.

In some embodiments, the baseplate 402 may include a single piece of material. For example, the baseplate 402 may include a single continuous piece of metal. In these and other embodiments, the cover 406 may include a single piece of material. For example, the cover 406 may include a single continuous piece of metal.

FIGS. 5A and 5B illustrate side views of a portion of the CMS 104 of FIGS. 1 and 2 in different installed positions. The first segment 360a and the second segment 360b may be installed on the installation surface such that a first gap 574, a second gap 576, or both are formed between the first segment 360a and the second segment 360b. In some embodiments, the first gap 574, the second gap 576, or both may be equal to or between zero inches and 1.5 inches.

The articulating joints 370 may include the articulating points 578. In some embodiments, the first segment 360a, the second segment 360b, or both may rotate relative to the articulating points 578 to create, adjust, or eliminate the first gap 574, the second gap 576, or both. As illustrated in FIG. 5, the first segment 360a may rotate relative to a first articulating point 578a (e.g., around a pin of the pivoting link 364) and the second segment 360b may rotate relative to a second articulating point 578b (e.g., around another pin of the pivoting link 364). Alternatively or additionally, the first segment 360a and the pivoting link 364 may both rotate relative to the second articulating point 578b or the second segment 360b and the pivoting link 364 may both rotate relative to the first articulating point 578a.

The segments 360 may rotate relative to the articulating points 578 according to a range of motion. The range of motion may be based on a length of the pivoting links 364, a height of the segments 360, or both. In some embodiments, the range of motion may be between negative thirty degrees and positive thirty degrees relative to each other.

As illustrated in a first view 500a, the first segment 360a may rotate such that an angle 572 between the segments 360 is equal to negative fifteen degrees (or other value). In addition, as illustrated in the first view 500a, the first segment 360a may rotate such that the first gap 574 is equal to 1.33 inches (or other value) and the second gap 576 is equal to 0.29 inches (or other value).

As illustrated in a second view 500b, the second segment 360b may rotate such that the angle 572 is equal to positive fifteen degrees (or other value). In addition, as illustrated in the second view 500b, the second segment may rotate such that the first gap 574 is equal to 0.22 inches (or other value) and the second gap 576 is equal to 1.26 inches (or other value).

FIG. 6 illustrates an example pivoting link 364 that may be implemented in the CMS 104 of FIGS. 1 and 2. The pivoting link 364 may include one or more pins 682. The pins 682 may extend from surfaces 684 of a body 680 of the pivoting link 364. In some embodiments, the surfaces 684 may be located on opposite sides of the body 680 from each other. In these and other embodiments, the pins 682 may extend parallel to other pins. Alternatively or additionally, the pins 682 may penetrate the body 680 such that opposite ends of the pins extend from different surfaces 684 of the pivoting link 364.

In some embodiments, one or more of the pins 682 may define cotter openings (not illustrated in FIG. 6). The cotter openings may be configured to interface with cotter pins (not illustrated in FIG. 6) to prevent the pivoting link 364 from unintentionally disconnecting from the CMS 104. For example, two or more of the pins 682 may interface with corresponding link openings 459 to partially extend within the volume 450 and the cotter pins may interface with the cotter openings to prevent the two or more pins 682 from completely passing back through the corresponding link openings 459. In some embodiments, the pivoting link 364 may include a double pivot metal plate link.

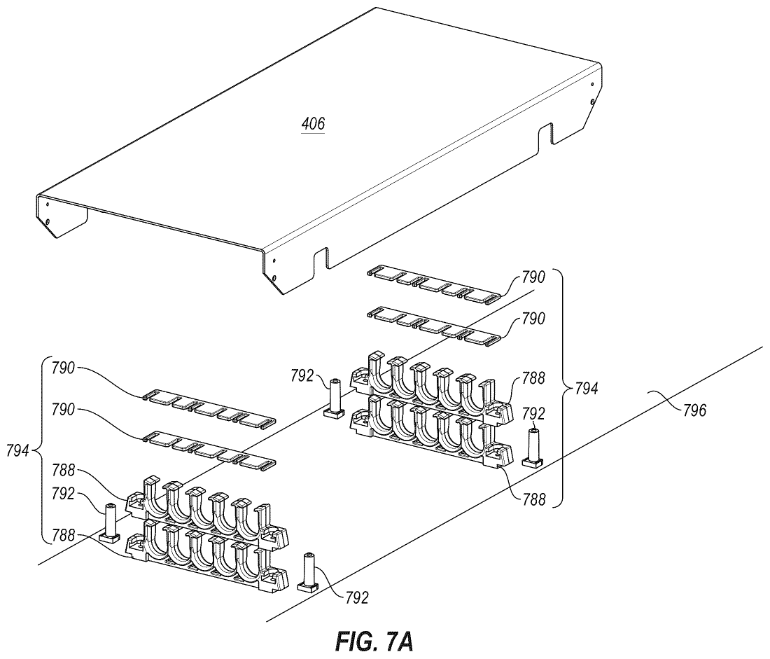

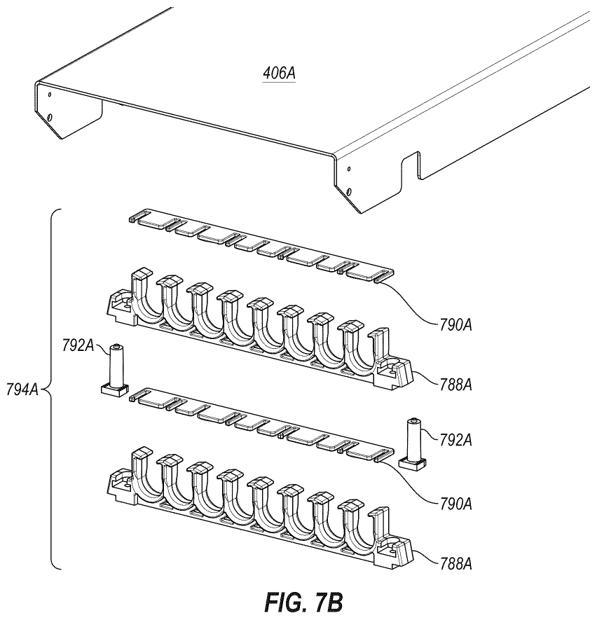

FIGS. 7A and 7B illustrate perspective views of the cover 406 and other components of the CMS 104 of FIGS. 1 and 2, including multicable clips 788. The multicable clips 788 include multiple channels to receive and secure multiple cables (not illustrated in FIG. 7A). For example, the multicable clips 788, as illustrated in FIG. 7A, may each include five channels to receive and secure five cables. FIG. 7B illustrates an alternative embodiment of a multicable clip 788A in which each multicable clip 788A includes eight channels to receive and secure eight cables (not illustrated in FIG. 7B). More generally, the number of channels included in each multicable clip 788, 788A may be one or more, such as five or eight as illustrated in FIGS. 7A and 7B, three, seven, ten, or other desired number of channels. Additionally, while each of the channels in the multicable clips 788, 788A have been described as receiving and securing a single cable in each channel, more generally each channel may receive and secure one or more cables, such as two cables per channel, three cables per channel, or other number of cables per channel. The dimensions of each channel or cable may be selected according to the number and size (e.g., gauge) of cables to be received in each channel. In these and other embodiments, the number of cables may be determined based on the National Electric Code.

Retention plates 790 or 790A may couple to the multicable clips 788 or 788A to retain the cables in the channels after placement therein. As illustrated, each of the multicable clips 788, 788A may be stacked with another multicable clip 788, 788A through risers 792, 792A. The risers 792, 792A may couple the multicable clips 788, 788A together (optionally with one or more threaded fasteners or other fasteners).

A set of stacked multicable clips 788, 788A together with corresponding retention plates 790, 790A and risers 792, 792A (and optional fasteners) may be referred to in the present disclosure as a stacked retention assembly 794, 794A. The stacked retention assemblies 794, 794A may be spaced apart along a length of the cover 406 to provide support and management of the cables along the length of the cover 406. For example, the stacked retention assemblies 794, 794A may be spaced every six to twenty-four inches or some other distance.

By stacking the multicable clips 788, 788A together, each stacked retention assembly 794, 794A may secure in a single location along the length of the cover 406 more cables than a single multicable clip 788, 788A by itself. The illustrated embodiment of FIG. 7A depicts each stacked retention assembly 794 as being able to secure ten cables (assuming there is one cable per channel), which is twice as many as one of the multicable clips 788 alone. Similarly, in the embodiment of FIG. 7B, the stacked retention assembly 794A may secure sixteen cables (assuming there is one cable per channel), which is twice as many as one of the multicable clips 788A alone.

Within each stacked retention assembly 794, 794A, one of the multicable clips 788, 788A will be closer to an installation surface 796 while the other multicable clip(s) 788, 788A is/are spaced further from the installation surface 796. In some embodiments, the installation surface 796 may correspond to an interior surface of the base wall 408 of the baseplate 402.

The cover 406 may engage at least one of the multicable clips 788, 788A of each stacked retention assembly 794, 794A along its length to enclose the stacked retention assemblies 794, 794A at least partially (or portions thereof) and the cables. For example, a retention flange or other structure of the cover 406 may engage a shoulder or other structure defined in a bottom of each base multicable clip 788, 788A.

Each multicable clip 788, 788A may be positioned within the volume 450 (not illustrated in FIGS. 7A and 7B). The multicable clip 788, 788A may engage the cover 406 (e.g., the segment 360).

FIGS. 8A and 8B illustrate perspective views of the multicable clip 788 of FIG. 7A. FIG. 8C illustrates a perspective view of one example of a pedestal 812B of the multicable clip 788 of FIG. 7A. As illustrated in FIGS. 8A and 8B, the multicable clip 788 includes a base 802 with multiple cradles 804 extending from the base 802. Only one of the cradles 804 is labeled in each of FIGS. 8A and 8B for ease of illustration.

The multicable clip 788 may further include clip arms 806 extending from the base 802. The clip arms 806 may extend in a common direction from the base 802 (e.g., orthogonally) with a proximal end of each clip arm 806 at the base 802 and a distal end of each clip arm 806 opposite the proximal end. Each of the cradles 804 is formed by the base 802 and a pair of adjacent clip arms 806. Only two clip arms 806 that are adjacent to each other are labeled in FIGS. 8A and 8B for ease of illustration. Each of the clip arms 806, except the two clip arms 806 at opposing ends of the multicable clip 788, form a portion of two adjacent cradles 804. The two clip arms 806 at the opposing ends of the multicable clip 788 each forms a portion of a single cradle 804 (e.g., of a corresponding one of the cradles 804 at the opposing ends of the multicable clip 788).

The multicable clip 788 may further include cradle retention fingers 808 extending from distal ends of the clip arms 806. Only two cradle retention fingers 808 are labeled in FIGS. 8A and 8B for ease of illustration. Each of the clip arms 806, except the two clip arms 806 at the opposing ends of the multicable clip 788, includes two cradle retention fingers 808 extending from its distal end. The two clip arms 806 at the opposing ends of the multicable clip 788 each includes a single cradle retention finger 808 extending from its distal end. According to the illustrated arrangement, each cradle 804 includes two cradle retention fingers 808 each extending at least partially toward the other cradle retention finger 808 or at least partially toward the opposing clip arm 806.

Each of the cradles 804 may include a cradle width w_{c} and an opening width wₒ. Only one of the cradle widths w_{c} and opening widths wₒ is labeled in FIG. 8A for ease of illustration. Other cradles 804 of the multicable clip 788 may have the same or different cradle widths w_{c} or opening widths wₒ. The cradle width w_{c} is the distance between clip arms 806 of a given cradle 804. The opening width wₒ is the distance between cradle retention fingers 808 of the given cradle 804. In some embodiments, the cradle width w_{c} may be greater than or equal to a cable outer diameter dₒ of the cables and the opening width wₒ may be less than the cable outer diameter dₒ.

The multicable clip 788 may include openings 810 defined by the base 802 or pedestals 812A, 812B (generally referred to in the present disclosure as pedestals 812) at opposite ends of the base 802. Only one opening 810 is labeled in each of FIGS. 8A and 8B for ease of illustration. The openings 810 may be positioned in the base 802 at the proximal ends of the clip arms 806 (e.g., a different opening 810 formed in the base 802 at the proximal end of each clip arm 806). Alternatively or additionally, the openings 810 may be positioned elsewhere in the base 802.

Each opening 810 may be configured to receive an elongated fastener such as a zip tie to secure a cable in a cradle 804. For example, a zip tie may be routed through one opening 810 at the first end of one clip arm 806 of the cradle 804, around the cable, through the other opening 810 at the first end of the other clip arm 806 of the cradle 804, and around the cable again to where ends of the zip tie may be joined together.

The pedestals 812 may be formed at opposite ends of the base 802 or may couple the multicable clip 788 to one or more installation structures. Each pedestal 812 may define a through hole 814A, 814B (generally referred to in the present disclosure as through holes 814) configured to receive a fastener. For example, a screw, a bolt, or other fastener may be inserted through each through hole 814 to secure the multicable clip 788 to the baseplate 402.

Each of the pedestals 812 may include a shoulder 816A, 816B (generally referred to in the present disclosure as shoulders 816) formed in the pedestal 812 to engage the cover 406. More particularly, each of the shoulders 816 may engage a corresponding retention flange of the cover 406.

Each of the pedestals 812 may further define a riser recess 818A, 818B (generally referred to in the present disclosure as riser recesses 818) having an interior shape that is complementary to an exterior shape of a portion of a corresponding riser 792 (or 792A) configured to be received in the riser recess 818. The pedestal 812A or other pedestals herein may be the same as, similar to, or different than the pedestal 812B depicted in FIG. 8C.

As illustrated in FIG. 8C, the riser recess 818B may include a neck portion 820A and an enlarged portion 820B. The neck portion 820A may have, at least at its opening, a neck width wₙ while the enlarged portion 820B may have, at least at its opening, an enlarged width wₑ that is greater than the neck width wₙ. An interior shape of the enlarged portion 820B may be complementary to an exterior shape of a base of a corresponding riser 792 such that the base of the riser 792 may be received in the enlarged portion 820B of the riser recess 818B. An interior shape of the neck portion 820A may be complementary to an exterior shape of a portion of a column of the riser 792 that is proximate to the base such that the portion of the column of the riser 792 that is proximate to the base of the riser may be received in the neck portion 820A of the riser recess 818B.

FIG. 9 illustrates the example segment 360 of FIGS. 4A-4C, including an anchor fastener 905. The anchor fastener 905 may include a connector 911, an anchor 907, and a cap 909. In some embodiments, the connector 911 may include a cable, a rod, or both. The anchor 907 may include a toggle lock anchor or toggle lock screw. In some embodiments, the anchor 907 may pin the segment 360 to the installation surface to prevent movement of the segment 360 relative to the installation surface.

The anchor 907 may be driven into the installation surface to a particular depth. In some embodiments, the particular depth may be equal to or between six inches and twenty-four inches. The anchor 907 while being driven may be in a closed state. In addition, the anchor 907, as illustrated in FIG. 9, may transition to an open state at the particular depth. For example, the connector 911 may be drawn toward the installation surface, which may cause wings of the anchor 907 to extend out and prevent the anchor 907 or the connector 911 from moving towards the installation surface. As another example, the connector 911 may be coupled to a threaded portion of the anchor 907 and the connector 911 may be rotated to extend the wings of the anchor 907 out. The cap 909 may be sized and shaped to prevent the cap 909 from passing through the anchor opening 446. For example, the cap 909 may be oversized compared to the anchor opening 446. As another example, the cap 909 may be shaped differently than the anchor opening 446 (e.g., a square shape compared to a circular shape).

An example in which the connector 911 includes a cable will now be discussed. The anchor 907 may be coupled to a first end 913 of the connector 911. The anchor 907 may be driven into the installation surface to the particular depth, which may cause a portion of the connector 911 to also be driven into the installation surface. A second end 915 of the connector 911 may extend above the installation surface and pass through the anchor opening 446. The second end 915 may engage the cap 909 to tension the connector 911 (e.g., cause the connector 911 to be taught). The tension on the connector 911 may draw the cap 909 towards the baseplate 402 (e.g., the base wall 408). In addition, the cap 909 may apply a force on the base wall 408 to draw the segment 360 towards the installation surface. In some embodiments, the cap 909 may draw the segment 360 towards the installation surface to cause the teeth 448 to interface with the installation surface.

An example in which the connector 911 includes a rod will now be discussed. The anchor 907 may be coupled to the first end 913 of the connector 911. The connector 911, the anchor 907, or both may be driven into the installation surface to the particular depth. The second end 915 of the connector 911 may extend above the installation surface and may include a connection portion, such as a threaded portion or a press fit portion. The second end 915 of the connector 911 may pass through the anchor opening 446. The cap 909 may include a fastener, such as a threaded fastener or a press-fit fastener, that interfaces with the connection portion of the second end 915. The cap 909 may attach to the connection portion of the second end 915 to draw the cap 909 towards the baseplate 402 (e.g., the base wall 408). In addition, the cap 909 may apply a force on the base wall 408 to draw the segment 360 towards the installation surface. In some embodiments, the cap 909 may draw the segment 360 towards the installation surface to cause the teeth 448 to interface with the installation surface.

The particular depth may be based on a material type of the installation surface. For example, the particular depth may be greater if the material type includes a loose soil compared to an asphalt material or cement material.

The segment 360 is illustrated in FIG. 9 as including the anchor fastener 905 as an example. The segment 360 may include other anchoring devices to secure the segment to the installation surface. For example, the segment 360 may include an earth screw to secure the segment 360 to the installation surface and prevent the segment 360 from moving relative to the installation surface.

FIGS. 10A-10C illustrate an exploded view, a perspective view, and a bottom perspective view of another example CMS 1000. FIG. 11 illustrates an overhead view of a portion of a baseplate 1002 of the CMS 1000 of FIGS. 10A-10C. With combined reference to FIGS. 10A-11, the CMS 1000 includes a drive-over CMS. The drive-over CMS may engage other drive-over CMSs or the pedestal bases 108 of FIG. 1. For example, the CMS 1000 may include a first drive-over CMS that engages with a second drive-over CMS (e.g., a neighboring CMS). The CMS 1000 is illustrated in FIGS. 10A-11 as including a single drive-over CMS as an example. More generally, the CMS 1000 may include any appropriate number of drive-over CMSs. For example, the CMS 1000 may include one, two, three, four, five, or more drive-over CMSs. In some embodiments, more drive-over CMSs may be added to the CMS 1000 to increase a length of the CMS 1000.

The CMS 1000 may include the baseplate 1002 and a cover 1006. The baseplate 1002 and the cover 1006 may be load bearing to permit vehicular travel or other travel along a top surface 1044 of the cover 1006 or to support other loads. For example, the CMS 1000 may permit an automobile, a truck, a vehicle, a human, or other transportation device to traverse the top surface 1044.

The baseplate 1002 may include a base wall 1008 and one or more support walls 1010. The support walls 1010 may extend from the base wall 1008 at any suitable angle, such as orthogonally (i.e., 90 degrees) or some other angle. The support walls 1010 may include gusset portions 1032 (illustrated in FIGS. 10A and 11). The gusset portions 1032 may extend from the support walls 1010 towards edges of the base wall 1008. The support walls 1010, including the gusset portions 1032, may support the cover 1006 to prevent the cover 1006 from collapsing due to the vehicular traffic.

The cover 1006 may include a top wall 1034, a first ramp portion 1018, and a second ramp portion 1022. The first ramp portion 1018 may extend diagonally from the top wall 1034 in a first direction. The second ramp portion 1022 may extend diagonally from top wall 1034 in a second direction. The cover 1006 may also include a first flange 1026 and a second flange 1030. The first flange 1026 may extend from the first ramp portion 1018. The second flange 1030 may extend from the second ramp portion 1022.

The baseplate 1002 may define attachment openings 1024 and the cover 1006 may define cover attachment openings 1028. A single instance of the attachment openings 1024 and a single instance of the cover attachment openings 1028 are numbered in FIGS. 10A-11 for ease of illustration.

The baseplate 1002 may include one or more protrusions 1020. The CMS 1000 may be configured to couple to neighboring CMSs via the protrusions 1020. For example, the protrusions 1020 may engage an opening defined by extension of a base wall 1008 of a neighboring CMS (not illustrated in FIGS. 10A-11). Alternatively, the protrusions 1020 may engage a coupler (not illustrated in FIGS. 10A-11) to couple the CMS 1000 to a neighboring CMS.

In some embodiments, a bottom surface 1012 of the cover 1006, when proximate or attached to the baseplate 1002, may engage, rest on, be supported by, or otherwise be associated with one or more upper surfaces 1014 of the support walls 1010. The cover 1006 may engage the baseplate 1002 to position the attachment openings 1024 proximate corresponding cover attachment openings 1028.

The attachment openings 1024 and the cover attachment openings 1028 may be configured to engage fasteners. The fasteners may cause the cover 1006 to couple to the baseplate 1002. In addition, the fasteners may prevent the cover 1006 from moving relative to the baseplate 1002. In other words, the fasteners engaging with the attachment openings 1024 and the cover attachment openings 1028 may prevent movement of the cover 1006 relative to the baseplate 1002.

In some embodiments, the fasteners may operate as grounding devices (e.g., grounding screws) in addition to attaching the cover 1006 to the baseplate 1002. In some embodiments, the fasteners may electrically couple or ground the cover 1006 to the baseplate 1002.

The baseplate 1002 and the cover 1006 may define a volume 1050 (illustrated in FIGS. 10B and 10C). The volume 1050 may permit a cable to pass through and route along a corresponding surface. For example, the cable may be accommodated or received in the volume 1050.

The cover 1006 may be removable from the CMS 1000 (as illustrated in FIG. 10A) to provide access to the base wall 1008. For example, removing the cover 1006 may expose the base wall 1008 to permit anchor fasteners to be installed or the cables to be routed through the volume 1050.

In some embodiments, the base wall 1008 may define one or more anchor openings 1046 (illustrated in FIGS. 10A, 10C, and 11). The anchor openings 1046 may be configured to interface with an anchor fastener (not illustrated in FIGS. 10A-11) to secure the CMS 1000 to an installation surface and prevent the CMS 1000 from moving relative to the installation surface. In some embodiments, the anchor fastener may include an earth screw. An example anchor fastener 905 is discussed in more detail above in relation to FIG. 9. The base wall 1008 is illustrated in FIGS. 10A, 10C, and 11 as defining eight anchor openings 1046 as an example. More generally, the base wall 1008 may define any appropriate number of anchor openings 1046. For example, the base wall 1008 may define one, two, three, four, five six, seven, nine or more anchor openings 1046.

The support walls 1010 may define one or more clip openings 1016. The baseplate 1002 may engage at least one multicable clip 788 along a length of the baseplate 1002 via the clip openings 1016. The clip openings 1016 may engage the at least one multicable clip 788 to enclose at least a portion of the multicable clip 788, the stacked retention assembly 794, the cables, or some combination thereof. For example, the clip openings 1016 may engage the shoulders 816 or other structure of the multicable clip 788.

As illustrated in FIG. 11, example clip openings 1016 may be configured to maintain a position of the multicable clip 788 relative to the base wall 1008. In some embodiments, the clip openings 1016 may be configured to maintain an orientation of the multicable clip 788.

In some embodiments, the baseplate 1002 may include a single piece of material. For example, the baseplate 1002 may include a single continuous piece of metal. In these and other embodiments, the cover 1006 may include a single piece of material. For example, the cover 1006 may include a single continuous piece of metal.

FIGS. 12A-12C illustrate a perspective view, a side view, and an overhead partial view of an example CMS 1204 that may be implemented in the system 100 of FIG. 1, the PV system 200 of FIG. 2, or both. In the example illustrated in FIGS. 12A-12C, the CMS 1204 may include an articulating CMS that includes a series of segments 1260a and 1260b (generally referred to in the present disclosure as segments 1260). For example, the CMS 1204 may include a first segment 1260a and a second segment 1260b. The CMS 1204 is illustrated in FIGS. 12A-12C as including two segments 1260 for simplicity. More generally, the CMS 1204 may include any appropriate number of segments 1260. For example, the CMS 1204 may include two, three, four, five, or more segments 1260. In some embodiments, more segments 1260 may be added to the CMS 1204 to increase a length of the CMS 1204. In these and other embodiments, the segments 1260 may be removed from or added to the CMS 1204 to alter the length of the CMS 1204. The first segment 1260a may define a first volume 1266. In addition, the second segment 1260b may define a second volume 1268.

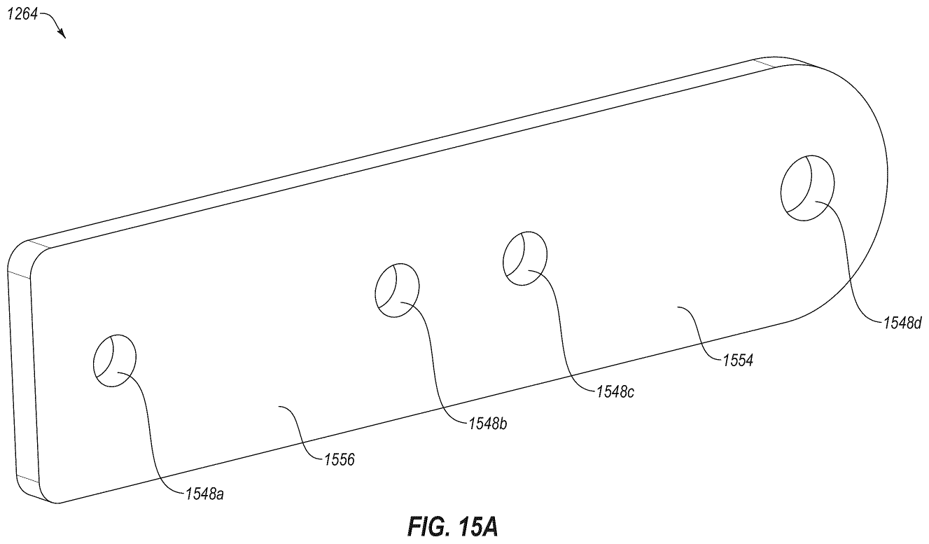

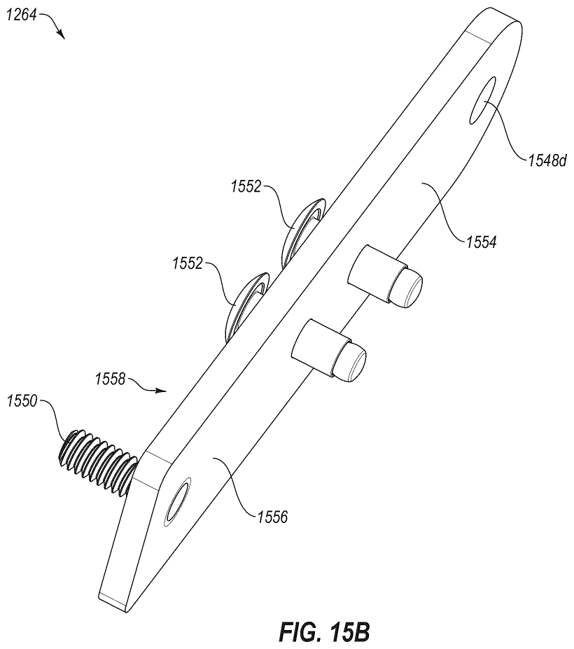

The CMS 1204 may include pivoting links 1264 (shown in FIGS. 12B and 12C). The pivoting links 1264 may couple to the first segment 1260a to prevent the first segment 1260a from rotating relative to the pivoting links 1264. Additionally or alternatively, the pivoting links 1264 may couple to the second segment 1260b to permit the second segment 1260b to rotate (e.g., pivot) relative the pivoting links 1264. In some embodiments, the CMS 1204 may include two pivoting links 1264 per coupling (e.g., seam) between the segments 1260. In other embodiments, the CMS 1204 may include one pivoting link 1264 per coupling (e.g., seam) between the segments 1260. An example of the pivoting links 1264 is discussed below in relation to FIGS. 15A and 15B.

The engagement between the pivoting links 1264 and the segments 1260 may form articulating joints 1270. The articulating joints 1270 may include an articulating point. The articulating points may operate the same as or similar to the articulating points 578 of FIG. 5.

The articulating joints 1270 may permit the second segment 1260b to rotate relative to the pivoting links 1264. For example, the articulating joints 1270 may permit the second segment 1260b to articulate in the vertical direction. In addition, the articulating joints 1270 may permit the CMS 1204 to contour to the installation surface, which may permit the first volume 1266 and the second volume 1268 to route a cable that also contours to the installation surface. The CMS 1204 may generally contour (e.g., conform) to the installation surface by articulating in the vertical direction while maintaining contact with at least a portion of the installation surface.

The segments 1260 may include two or more channel portions 1202 that are configured to couple to each other to form multiple channels within the segments 1260. As discussed in more detail below, the channel portions 1202 may bisect the first volume 1266, the second volume 1268, or both to provide segmented volumes for the cables to be routed through. In addition, the channel portions 1202 may engage covers 1206 of the segments 1260 to limit or prevent deflection of the covers 1206 when a load traverses the segments 1260.

In some embodiments, the segments 1260 (e.g., adjacent segments) may be electrically coupled to each other to ground the entire CMS 1204. For example, the CMS 1204 may include ground studs (not illustrated in FIGS. 12A-12C) electrically coupled to the segments 1260. The ground studs may electrically ground the CMS 1204.

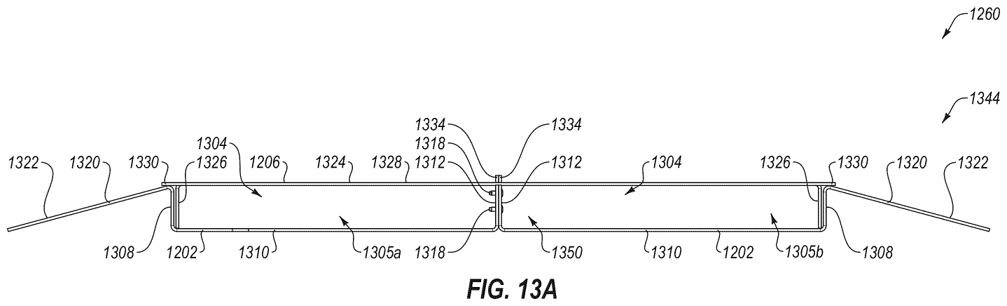

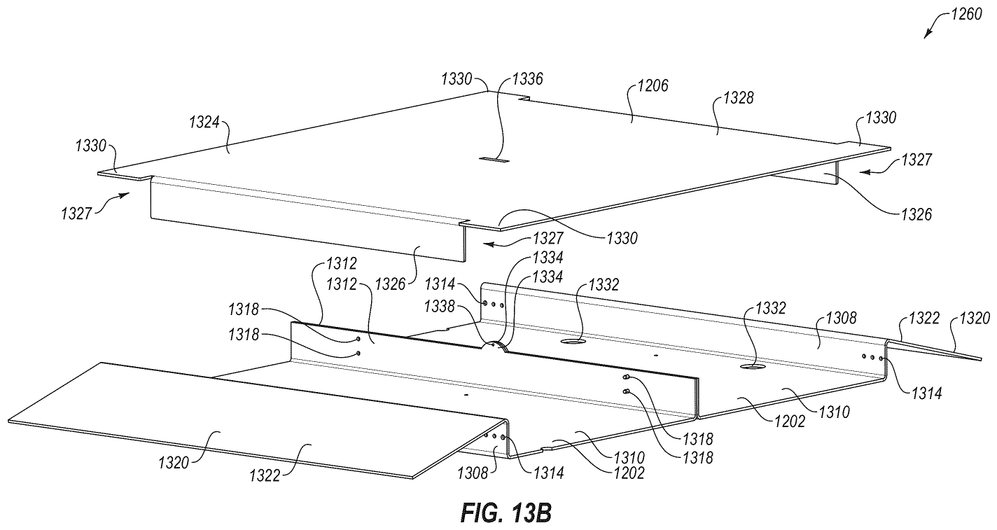

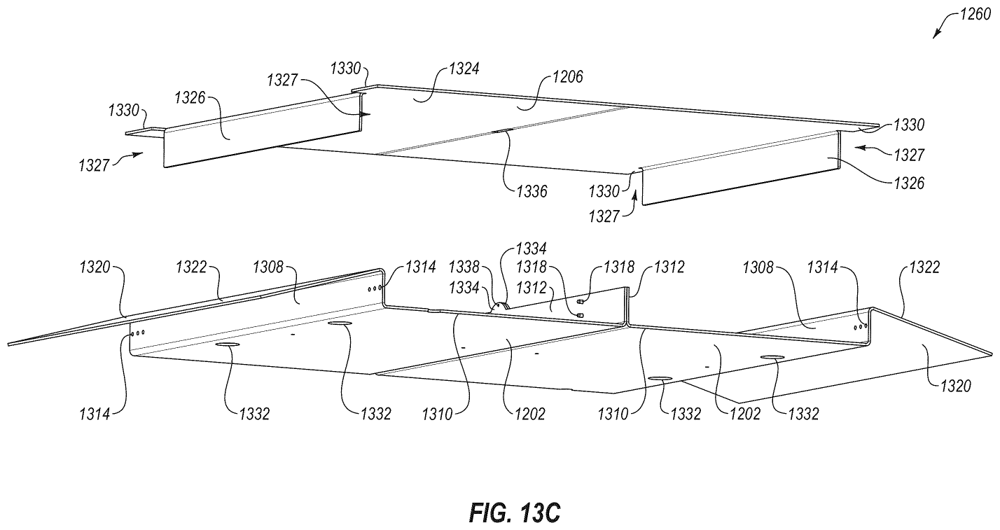

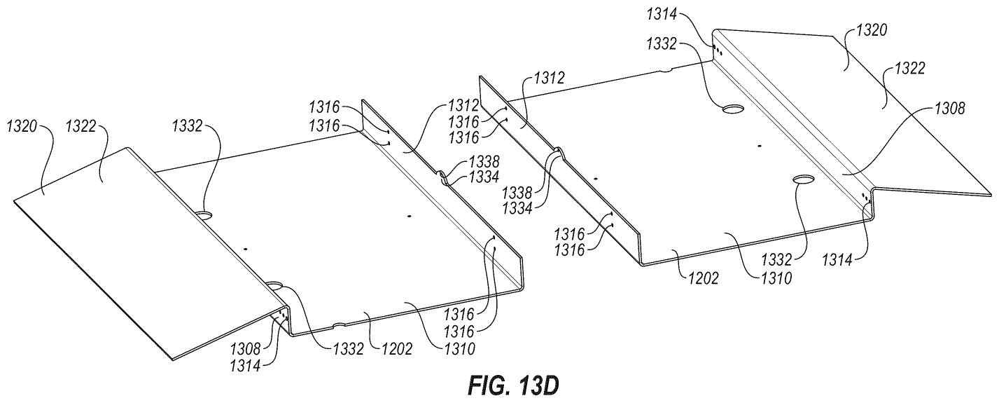

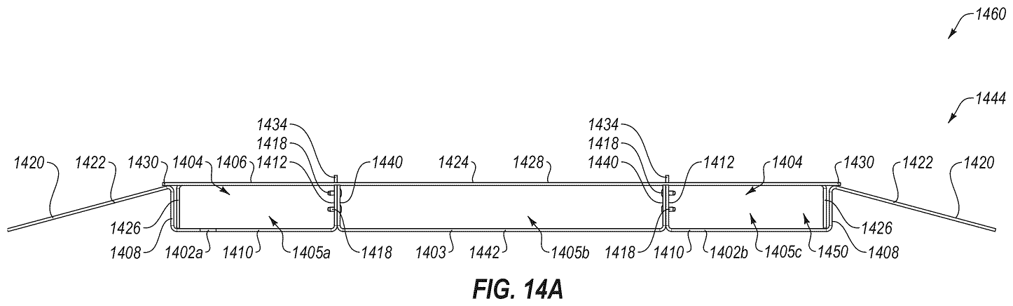

FIGS. 13A-13D illustrate a front view, a partially exploded side perspective view, a partially exploded bottom perspective view, and a perspective view of components of an example segment 1260 of the CMS 1204 of FIGS. 12A-12C. The segment 1260 may correspond to the first segment 1260a or the second segment 1260b.

The channel portions 1202 and the cover 1206 may at least partially define a volume 1350 (illustrated in FIG. 13A). The volume 1350 may correspond to the first volume 1266 or the second volume 1268 of FIGS. 12A-12C. In addition, the channel portions 1202 and the cover 1206 may define the volume 1350 to include the multiple sub-volumes 1305a-b (illustrated in FIG. 13A). In particular, a first instance of the channel portion 1202 and part of the cover 1206 may at least partially define a first sub-volume 1305a and a second instance of the channel portion 1202 and another part of the cover 1206 may at least partially define a second sub-volume 1305b. Each of the sub-volumes 1305a-b may form channels that are configured to receive cables. For example, the first sub-volume 1305a may be configured to receive a first cable and the second sub-volume 1305b may be configured to receive a second cable.

The channel portions 1202 and the cover 1206 may include a top surface 1344 (illustrated in FIG. 13A). In addition, the channel portions 1202 and the cover 1206 may be load bearing to permit vehicular travel or other travel along or loads upon the top surface 1344. For example, the channel portions 1202 and the cover 1206 may permit an automobile, a truck, a vehicle, a human, or other transportation device to traverse or be supported by the top surface 1344.

Each of the channel portions 1202 may include a first sidewall 1308, a base wall 1310, a second sidewall 1312, or a ramp portion 1320. The ramp portion 1320 may extend diagonally from the first sidewall 1308. In addition, the ramp portion 1320 may include a top surface 1322. In some embodiments, the first sidewall 1308, the base wall 1310, or the second sidewall may define an opening 1304.

The second sidewall 1312 may be configured to couple to an adjacent second sidewall 1312 such that the coupled second sidewalls 1312 bisect the volume 1350 to define the sub-volumes 1305a-b. The first sidewall 1308 may be connected to a side of the base wall 1310. Additionally or alternatively, the second sidewall 1312 may be connected to an opposite side of the base wall 1310 as the first sidewall 1308. In some embodiments, the first sidewall 1308 may be parallel to the second sidewall 1312.

The first sidewall 1308 may define segment openings 1314 (shown in FIGS. 13B-13D). In some embodiments, the segment openings 1314 may interface with fasteners (such as denoted 1550 or 1552 in FIG. 15B) of the pivoting links 1264 (not illustrated in FIGS. 13A-13D). In some embodiments, the segment openings 1314 may interface with a pivoting link 1264 to couple the pivoting link 1264 to the first sidewall 1308. In these and other embodiments, the segment openings 1314 may interface with the pivoting link 1264 to prevent movement of the pivoting link 1264 along a longitudinal axis of the first sidewall 1308.

Referring to FIGS. 12A-12C and FIGS. 13A-13D, the segment openings 1314 of the first segment 1202a may interface with the pivoting links 1264 to prevent rotation of the first segment 1202a relative to the pivoting links 1264. In some embodiments, the segment openings 1314 of the first segment 1202a may interface with multiple instances of the fasteners of the pivoting links 1264 to prevent rotation of the first segment 1260a relative to the pivoting links 1264.

In some embodiments, the segment openings 1314 of the second segment 1202b may interface with the pivoting links 1264 to form the articulating joints 1270 and permit rotation of the second segment 1202b relative to the pivoting links 1264. In these and other embodiments, the segment openings 1314 of the second segment 1202b may interface with single instances of the fasteners of the pivoting links 1264 to permit rotation of the second segment 1260b relative to the pivoting links 1264.

Returning back to FIGS. 13A-13D, the multiple openings of the segment openings 1314 may permit a gap between adjacent segments 1260 to be adjusted; for example, the gap between the adjacent segments 1260 may be reduced by the pivoting links 1264 interfacing with a middle opening, an inner opening, or both of the segment openings 1314 compared to the pivoting links 1264 interfacing with an outer opening or both the outer opening and the middle opening of the segment openings 1314.

The segment openings 1314 in FIGS. 13B-13D include three circular openings for example purposes. However, the segment openings 1314 may include any appropriate number (e.g., one, two, four, or more) of individual openings or any appropriate shape (e.g., rectangle, square, triangle, octagon)

The second sidewall 1312 may define one or more attachment openings 1316 (illustrated in FIG. 13D). In some embodiments, the attachment openings 1316 may be configured to interface with fasteners 1318 (illustrated in FIGS. 13A-13C) to couple the adjacent channel portions 1202 to each other. In particular, the attachment openings 1316 may be configured to interface with the fasteners 1318 to couple adjacent second sidewalls 1312 to each other. The fasteners 1318 may include, e.g., self-tapping screws, grounding screws, nuts and bolts, or other fasteners. The fasteners 1318 may prevent the adjacent channel portions 1202 from unintentionally uncoupling from each other. Additionally or alternatively, the fasteners 1318 interfacing with the attachment opening 1316, the second sidewalls 1312, or both may prevent movement of the channel portions 1202 relative to each other.

The cover 1206 may include a top wall 1324 and sidewalls 1326. The top wall 1324 may include a top surface 1328. The cover 1206 may engage the channel portions 1202 to position the cover 1206 relative to the channel portions 1202. In addition, the cover 1206 may include one or more flanges 1330 that are configured to engage with the first sidewalls 1308. As shown in FIG. 13A, the cover 1206 may be sized to engage with two adjacent channel portions 1202. Further, the cover 1206 may engage the adjacent channel portions 1202 to position the sidewalls 1326 of the cover 1206 proximate the first sidewalls 1308.

In some embodiments, the sidewalls 1326 of the cover 1206 may extend along a portion of the cover 1206 to define link cutouts 1327 (shown in FIGS. 13B and 13C). The link cutouts 1327 may permit the pivoting links 1264 to engage only the channel portions 1202. In these and other embodiments, the flanges 1330 may provide load bearing support for at least a portion of the top wall 1324 proximate the link cutouts 1327 to limit deformation of at least the portion of the top wall 1324 when a load traverses the top surface 1344.

In some embodiments, the ramp portion 1320 of the adjacent channel portions 1202 and the cover 1206 may permit a vehicle to traverse the top surfaces 1322 of the ramp portions 1320 and the top surface 1328 of the cover 1206. In these and other embodiments, the top surface 1344 may include a combination of the top surfaces 1322 of the ramp portions 1320 and the top surface 1328 of the cover 1206.

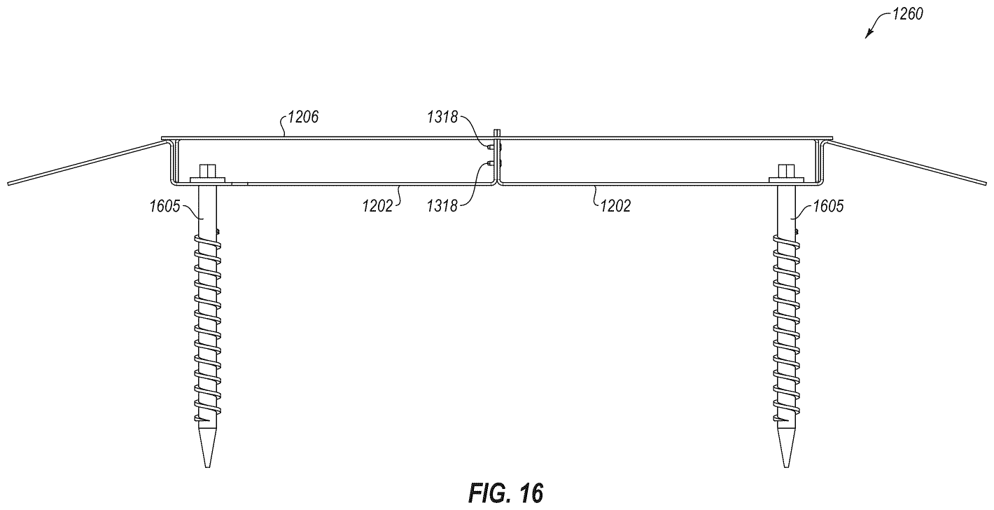

In some embodiments, one or more of the channel portions 1202 may define anchor openings 1332 (illustrated in FIGS. 13B-13D). The anchor openings 1332 may be configured to interface with an anchor fastener (not illustrated in FIGS. 13A-13D) to secure the segment 1260 to the installation surface and prevent the segment 1260 from moving relative to the installation surface. An example in which the anchor fastener includes an earth screw is discussed in below in relation to FIG. 16. The channel portions 1202 are illustrated in FIGS. 13B-13D as defining two anchor openings 1332 as an example. More generally, the channel portions 1202 may define one or more anchor openings 1332, such as one, three, four, five, or more anchor openings 1332.

The cover 1206 may be removable from the segment 1260, as illustrated in FIGS. 13B and 13C, to provide access to the channel portions 1202. For example, removing the cover 1206 may expose the sub-volumes 1305a-b to permit the anchor fasteners to be installed or the cables to be routed through the volume 1350.

In some embodiments, the second sidewall 1312 may include a protrusion 1334. Alternatively, the protrusion 1334 of one or more of the second sidewalls 1312 of the adjacent channel portions 1202 may be omitted. Additionally, the cover 1206 may define a cover opening 1336 (illustrated in FIGS. 13B and 13C). The cover opening 1336 may be configured to receive the protrusion 1334. The protrusion 1334, when received by the cover opening 1336, may at least partially extend beyond the top surface 1328 of the cover 1206. In some embodiments, the cover opening 1336 receiving the protrusion 1334 may align, position, or both the cover 1206 relative to the channel portions 1202. Additionally or alternatively, the sidewalls 1326 of the cover 1206 engaging the first sidewalls 1308 of the adjacent channel portions 1202 may align, position, or both the cover 1206 relative to the adjacent channel portions 1202.

The protrusion 1334 may define a fastener opening 1338 (illustrated in FIG. 13B-13D). The second sidewall 1312 may be configured to couple to the adjacent second sidewall 1312 such that the fastener openings 1338 of adjacent protrusions 1334 are generally aligned as illustrated in FIGS. 13A-13C. The fastener openings 1338 of the adjacent channel portions 1202 may be aligned to permit a fastener (not illustrated) to pass through the fastener openings 1338 to couple the cover 1206 to the adjacent channel portions 1202. The protrusion 1334, when received by the cover opening 1336, may at least partially extend beyond the top surface 1328 of the cover 1206 such that the fastener opening 1338 is proximate the top surface 1328 of the cover 1206. The fastener may include, e.g., self-tapping screws, grounding screws, nuts and bolts, or other fasteners. The fastener may prevent the cover 1206 from unintentionally disengaging the adjacent channel portions 1202. The fasteners interfacing with the fastener opening 1338, the protrusion 1334, or both may prevent movement of the cover 1206 relative to the channel portions 1202.

The cover 1206 may engage the channel portions 1202 within at least portions of the openings 1304 defined by the adjacent channel portions 1202. Additionally or alternatively, the cover 1206 may engage the first sidewalls 1308 of the adjacent channel portions 1202. In some embodiments, the cover 1206 may engage the first sidewalls 1308 to limit deflection of the cover 1206 between the sidewalls 1326 of the cover 1206 and the second sidewalls 1312 when a load is on or traverses the top surface 1344. The first sidewall 1308, when engaged with the cover 1206, may limit deflection to 0.4 centimeters or less from a default position. An example of the cover 1206 in the default position is illustrated in FIG. 13A.

In some embodiments, one or more of the channel portions 1202, the cover 1206, or some combination thereof may include single pieces of material. For example, one or more of the channel portions 1202 may include single continuous pieces of metal. As another example, the cover 1206 may include a single continuous piece of metal.

In some embodiments, one or more of the ramp portions 1320 of the adjacent channel portions 1202 may include teeth (e.g., similar to teeth 448 discussed above) (not shown). The teeth may interface with or engage the installation surface to prevent the segment 1260 from moving relative to the installation surface in any direction along the installation surface. In these and other embodiments, the teeth

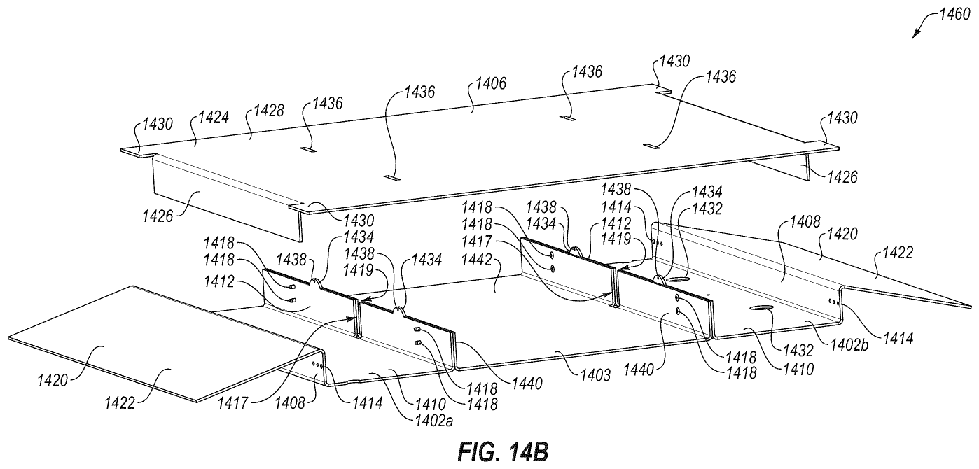

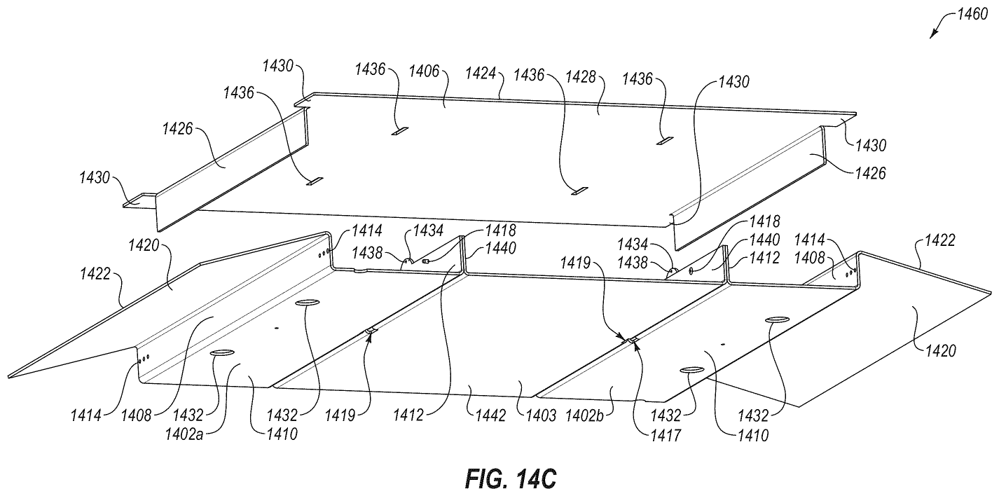

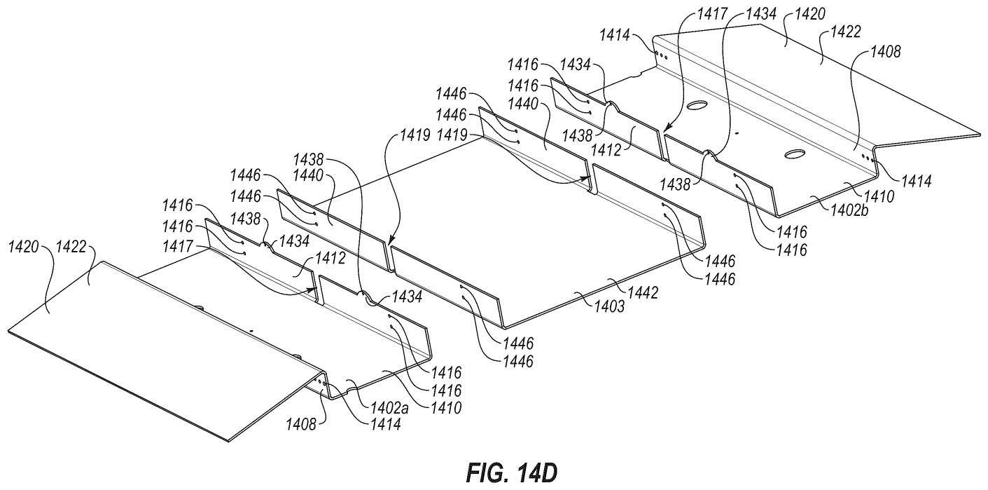

FIGS. 14A-14D illustrate a front view, a partially exploded side perspective view, a partially exploded bottom perspective view, and a perspective view of components of an example segment 1460 that includes two channel portions 1402a-b and a middle channel portion 1403. The segment 1460 may operate similar to the segment 1260 of FIGS. 13A-13D except that the segment 1460 includes two channel portions 1402a-b and a middle channel portion 1403 instead of two channel portions 1202. The channel portions 1402a-b and the middle channel portion 1403 may create more channels to route the cables compared to the two channel portions 1202 of the segment 1260 of FIGS. 13A-13D.

In some embodiments, the channel portions 1402a-b may be outer channel portions and along with the middle channel portion 1403 may form the segment 1460. In other embodiments, the channel portions 1402a-b may be the outer channel portions and along with multiple instances of the middle channel portion 1403 may form the segment 1460. A width of the segment 1460 may be adjusted by inclusion of more or fewer instances of the middle channel portion 1403. For example, the width of the segment 1460 may be adjusted to be greater by including two or more instances of the middle channel portion 1403 compared to when the segment 1460 includes a single instance of the middle channel portion 1403. Each additional instance of the middle channel portion 1403 may form another channel to route cables through.

The segment 1460 may include a cover 1406 that at least partially defines a volume 1450 (illustrated in FIG. 14A). In addition, the channel portions 1402a-b, the middle channel portion 1403, or the cover 1406 may define the volume 1450 to include the multiple sub-volume 1405a-c (illustrated in FIG. 14A). In particular, the channel portion 1402a and part of the cover 1406 may at least partially define a first sub-volume 1405a, the middle channel portion 1403 and another part of the cover 1406 may at least partially define a second sub-volume 1405b, and the channel portion 1402b and another part of the cover 1406 may define a third sub-volume 1405c. Each of the sub-volumes 1405a-c may form channels that are configured to receive cables. For example, the first sub-volume 1405a may be configured to receive a first cable, the second sub-volume 1405b may be configured to receive a second cable, and the third sub-volume 1405c may be configured to receive a third cable.

The channel portions 1402a-b and the cover 1406 may include a top surface 1444 (illustrated in FIG. 14A). In addition, the channel portions 1402a-b, the middle channel portion 1403, or the cover 1406 may be load bearing to permit vehicular travel or other travel along or loads upon the top surface 1444. For example, the channel portions 1402a-b and the cover 1406 may permit an automobile, a truck, a vehicle, a human, or other transportation device to traverse or be supported by the top surface 1444.

Each of the channel portions 1402a-b may include a first sidewall 1308, a base wall 1410, a second sidewall 1412, and a ramp portion 1420. The ramp portion 1420 may extend diagonally from the first sidewall 1408. In addition, the ramp portion 1420 may include a top surface 1422. In some embodiments, the first sidewall 1408, the base wall 1410, or the second sidewall may define an opening 1404. In addition, the middle channel portion 1403 may include sidewalls 1440 and a base wall 1442.

The second sidewall 1412 may be configured to couple to an adjacent instances of the sidewalls 1440 of the middle channel portion 1403 such that the second sidewalls 1312 and the sidewalls 1440 of the middle channel portion 1403 bisect the volume 1450 to define the sub-volumes 1405a-c. The first sidewall 1408 may be connected to a side of the base wall 1410. Additionally or alternatively, the second sidewall 1412 may be connected to an opposite side of the base wall 1410 as the first sidewall 1408. In some embodiments, the first sidewall 1408 may be parallel to the second sidewall 1412.

The first sidewall 1408 may define segment openings 1414 (shown in FIGS. 14B-14D). In some embodiments, the segment openings 1414 may interface with fasteners (such as denoted 1550 or 1552 in FIG. 15B) of the pivoting links 1264 (not illustrated in FIGS. 14A-14D). In some embodiments, the segment openings 1414 may interface with a pivoting link 1264 to couple the pivoting link 1264 to the first sidewall 1408. In these and other embodiments, the segment openings 1414 may interface with the pivoting link 1264 to prevent movement of the pivoting link 1264 along a longitudinal axis of the first sidewall 1408.

The segment openings 1414 may operate the same as or similar to the segment openings 1314 of the segment 1260 to prevent one instance of the segment 1460 from rotating relative to the pivoting links 1264. In addition, the segment openings 1414 may operate the same as or similar to the segment openings 1314 of the segment 1260 to permit another instance of the segment 1460 to rotate relative to the pivoting links 1264.

The multiple openings of the segment openings 1414 may permit a gap between adjacent segments 1460 to be adjusted; for example, the gap between the adjacent segments 1460 may be reduced by the pivoting links 1264 interfacing with a middle opening, an inner opening, or both of the segment openings 1414 compared to the pivoting links 1264 interfacing with an outer opening or both the outer opening and the middle opening of the segment openings 1414.

Each instance of the segment openings 1414 in FIGS. 14B-14D includes three circular openings for example purposes. However, the segment openings 1414 may include any appropriate number (e.g., one, two, four, or more) of individual openings or any appropriate shape (e.g., rectangle, square, triangle, octagon)

The second sidewall 1412 may define one or more attachment openings 1416 (illustrated in FIG. 14D). Additionally or alternatively, the sidewalls 1440 of the middle channel portion 1403 may define one or more openings 1446 (illustrated in FIG. 14D). The second sidewalls 1412 may be configured to couple to the sidewalls 1440 of the middle channel portion 1403 such that the attachment openings 1416 are generally aligned with the openings 1446 defined by the sidewalls 1440. In some embodiments, the attachment openings 1416 and the openings 1446 defined by the sidewalls 1440 may be configured to interface with fasteners 1418 (illustrated in FIGS. 14A-14C) to couple the channel portions 1402a-b to the middle channel portion 1403. The fasteners 1418 may include, e.g., self-tapping screws, grounding screws, nuts and bolts, or other fasteners. The fasteners 1418 may prevent the channel portions 1402a-b from unintentionally uncoupling from the middle channel portion 1403. In other words, the fasteners 1418 interfacing with the attachment opening 1416, the second sidewalls 1312, the openings 1446 of the sidewalls 1440, or the sidewalls 1440 may prevent movement of the channel portions 1402a-b relative to the middle channel portion 1403.

The second sidewalls 1412 may define one or more clip openings 1417. In addition, the sidewalls 1440 may define one or more additional clip openings 1419. The channel portions 1402a-b or the middle channel portion 1403 may engage at least one multicable clip (e.g., multicable clip 788 not shown in FIGS. 14A-14D) via the clip openings 1417 or the additional clip openings 1419. The clip openings 1417 or the additional clip openings 1419 may engage the at least one multicable clip to enclose at least a portion of the multicable clip. For example, the clip openings 1417 or the additional clip openings 1419 may engage the shoulders 816 or other structure of the multicable clip 788.

The clip openings 1417 or the additional clip openings 1419 may be configured to maintain a position of the multicable clip relative to the channel portions 1402a-b or the middle channel portion 1403. In some embodiments, the clip openings 1417 or the additional clip openings 1419 may be configured to maintain an orientation of the multicable clip 788.

The cover 1406 may include a top wall 1424 and sidewalls 1426. The top wall 1424 may include a top surface 1428. The cover 1406 may engage the channel portions 1402a-b or the middle channel portion 1403 to position the cover 1406 relative to the channel portions 1402a-b or the middle channel portion 1403. In addition, the cover 1406 may include one or more flanges 1430 that are configured to engage with the first sidewalls 1408. The flanges 1430 . . . . As shown in FIG. 14A, the cover 1406 may be sized to engage with the two channel portions 1402a-b and the middle channel portion 1403. Alternatively, the cover 1406 may be sized to engage with four or more adjacent channel portions (e.g., the segment 1460 when it includes multiple instances of the middle channel portion 1403). Further, the cover 1406 may engage the channel portions 1402a-b or the middle channel portion 1403 to position the sidewalls 1426 of the cover 1406 proximate the first sidewalls 1408.

In some embodiments, the ramp portions 1420 of the channel portions 1402a-b and the cover 1406 may permit a vehicle to traverse the top surfaces 1422 of the ramp portions 1420 and the top surface 1428 of the cover 1406. In these and other embodiments, the top surface 1444 may include a combination of the top surfaces 1422 of the ramp portions 1420 and the top surface 1428 of the cover 1406.

In some embodiments, the channel portions 1402a-b may define anchor openings 1432 (illustrated in FIGS. 14B-14D). The anchor openings 1432 may be configured to interface with an anchor fastener (not illustrated in FIGS. 14A-14D) to secure the segment 1460 to the installation surface and prevent the segment 1460 from moving relative to the installation surface. In some embodiments, the anchor fastener may include an earth screw. The channel portions 1402a-b are illustrated in FIGS. 14B-14D as defining two anchor openings 1432 as an example. More generally, one or more of the channel portions 1402a-b or the middle channel portion 1403 may define one or more anchor openings 1432, such as one, three, four, five, or more anchor openings 1432.

The cover 1406 may be removable from the segment 1460, as illustrated in FIGS. 14B and 14C, to provide access to the channel portions 1402a-b or the middle channel portion 1403. For example, removing the cover 1406 may expose the sub-volumes 1405a-c to permit the anchor fasteners to be installed or the cables to be routed through the volume 1450.

In some embodiments, one or more of the second sidewalls 1412 may include a protrusion 1434. In these or other embodiments, one or more of the sidewalls 1440 of the middle channel portion 1403 may include a protrusion (not shown). Alternatively, one or more of the protrusions 1434 may be omitted. Additionally, the cover 1406 may define cover openings 1436 (illustrated in FIGS. 14B and 14C). The cover openings 1436 may be configured to receive the protrusions 1434. The protrusions 1434, when received by the cover openings 1436, may at least partially extend beyond the top surface 1428 of the cover 1406. In some embodiments, the cover openings 1436 receiving the protrusions 1334 may align, position, or both the cover 1406 relative to the channel portions 1402a-b or the middle channel portion 1403. Additionally or alternatively, the sidewalls 1426 of the cover 1406 engaging the first sidewalls 1408, the sidewalls 1440 of the middle channel portion 1403, or both may align, position, or both the cover 1406 relative to the channel portion 1402a-b or the middle channel portion 1403.

The protrusion 1434 may define a fastener opening 1438 (illustrated in FIG. 14B-14D). In some embodiments, the second sidewalls 1412 may be configured to couple to the sidewalls 1440 of the middle channel portion 1403 such that the fastener openings 1438 of adjacent protrusions 1434 are generally aligned. The fastener openings 1438 may permit fasteners (not illustrated) to pass through the fastener openings 1438 to couple the cover 1406 to the middle channel portion 1403 or the channel portions 1402a-b. The protrusions 1434, when received by the cover openings 1436, may at least partially extend beyond the top surface 1428 of the cover 1406 such that the fastener openings 1438 are proximate the top surface 1428 of the cover 1406. The fasteners may include, e.g., self-tapping screws, grounding screws, nuts and bolts, or other fasteners. The fasteners may prevent the cover 1406 from unintentionally disengaging the middle channel portion 1403 or the channel portions 1402a-b. In other words, the fasteners interfacing with the fastener openings 1438, the protrusions 1434, or both may prevent movement of the cover 1406 relative to the middle channel portion 1403 or the channel portions 1402a-b.

The cover 1406 may engage the channel portions 1402a-b within at least portions of the openings 1404 defined by the channel portions 1402a-b. Additionally or alternatively, the cover 1406 may engage the first sidewalls 1408 of the channel portions 1402a-b. In some embodiments, the cover 1406 may engage the first sidewalls 1408 to limit deflection of the cover 1406 between the sidewalls 1426 of the cover 1406 and the second sidewalls 1412 when a load is on or traverses the top surface 1444. The first sidewall 1408, when engaged with the cover 1406, may limit deflection to 0.4 centimeters or less from a default position. An example of the cover 1406 in the default position is illustrated in FIG. 14A.

In some embodiments, one or more of the channel portions 1402a-b, the middle channel portion 1403, the cover 1406, or some combination thereof may include single pieces of material. For example, one or more of the channel portions 1402a-b or the middle channel portion 1403 may include single continuous pieces of metal. As another example, the cover 1406 may include a single continuous piece of metal.

In some embodiments, one or more of the ramp portions 1420 of the channel portions 1402a-b13116

may include teeth (e.g., similar to teeth 448 discussed above) (not shown). The teeth may interface with or engage the installation surface to prevent the segment 1460 from moving relative to the installation surface in any direction along the installation surface. In these and other embodiments, the teeth

FIGS. 15A and 15B illustrate a perspective view of a body 1554 of an example pivoting link 1264 and a perspective view of the example pivoting link 1264 that may be implemented in the CMS 1204 of FIGS. 12A-12C. Additionally or alternatively, the example pivoting link 1264 may be implemented with multiple instances of the segment 1460 of FIGS. 14A-14D.

As shown in FIG. 15A, the pivoting link 1264 may define link openings 1548a-d. The link openings 1548a-d may be configured to align with one or more of the segment openings 1314 or 1414 of the segment 1260 or 1460. Additionally or alternatively, the pivoting link 1264 may define the link openings 1548a-d to align with the segment openings 1314 or 1414 of adjacent instances of the segment 1260 or 1460 to permit one of the segments 1260 or 1460 to rotate and to prevent the other segment 1260 or 1460 from rotating.

Additionally, as shown in FIG. 15B, the pivoting link 1264 may include fasteners 1550 or 1552. The fasteners 1550 or 1552 may include one or more rivets, threaded fasteners, a clevis pin, or any other appropriate fastener. The link openings 1548a-d may be configured to receive the fasteners 1550 or 1552. The link openings 1548a-d may receive the fasteners 1550 or 1552 such that a portion of the fasteners extend from a body 1554 of the pivoting link 1264. In some embodiments, one or more of the fasteners 1550 or 1552 may penetrate the body 1554 such that one or more ends of the fasteners 1550 or 1552 are positioned within the corresponding link openings 1548a-d or flush with a surface 1556 of the pivoting link 1264. For example, as shown in FIG. 15B, an end of the fastener 1550 is flush with the surface 1556 of the pivoting link 1264. Alternatively or additionally, the fasteners 1550 or 1552 may penetrate the body 1554 such that one or more ends of the fasteners 1550 or 1552 extend from different surfaces 1556 and 1558 of the pivoting link 1264. For example, as shown in FIG. 15B, ends of the fasteners 1552 extend from the surfaces 1556 and 1558. The fasteners 1550, as shown in FIG. 15B, may include rivets that are installed during manufacturing of the pivoting link 1264. Additionally or alternatively, the fastener 1552, as shown in 15B, may include a threaded fastener to permit the fastener 1552 to be installed in the field.

Two or more of the link openings 1548a-d may be configured to align with two or more of the segment openings 1314 or 1414 of the segment 1260 or 1460. For example, two or more of the link openings 1548a-c may align with the inner opening, middle opening, or the outer openings of the segment openings 1314 or 1414. The two or more of the link openings 1548a-c may align with the two or more segment openings 1314 or 1414 to permit the two or more segment openings 1314 or 1414 and the two or more link openings 1548a-c to receive the fasteners 1550. The two or more segment openings 1314 or 1414 and the two or more link openings 1548a-c receiving the fasteners 1550 may prevent the segment 1260 or 1460 from rotating relative to the pivoting link 1264.

One of the link openings 1548c-d may be configured to align with one of the segment openings 1314 or 1414 of the segment 1260 or 1460. For example, one of the link openings 1548c-d may align with the inner opening, the middle opening, or the outer openings of the segment openings 1314 or 1414. The one link opening 1548c-d may align with the one segment opening 1314 or 1414 to permit the one segment opening 1314 or 1414 and the one link opening 1548c-d to receive the fastener 1552. The one segment opening 1314 or 1414 and the one link opening 1548c-d receiving the fastener 1552 may form the articulating joints 1270 to permit the segment 1260 or 1460 to rotate relative to the pivoting link 1264.

The fasteners 1550 or 1552 may include, e.g., self-tapping screws, grounding screws, nuts and bolts, or other fasteners. The pivoting link 1264 may prevent adjacent segments 1260 or 1460 from unintentionally uncoupling from each other. The fasteners 1550 or 1552 may operate as grounding devices (e.g., grounding screws).

FIG. 16 illustrates the example segment 1260 of FIGS. 13A-13D, including anchor fasteners 1605. In some embodiments, the anchor fasteners 1605 may pin the segment 1260 to the installation surface to prevent movement of the segment 1260 relative to the installation surface. The anchor fasteners 1605 as shown includes earth screws.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A cable management system comprising:
a first segment defining a first volume configured to receive a cable;
a second segment defining a second volume configured to receive the cable; and
a pivoting link configured to couple to the first segment to prevent rotation of the first segment relative to the pivoting link and configured to couple to the second segment to form an articulating joint configured to permit the second segment to rotate relative to the pivoting link.

2. The cable management system of claim 1, wherein:
the first segment defines a first plurality of segment openings;
the second segment defines a second plurality of segment openings;
the pivoting link defines a plurality of link openings;
two or more of the link openings are configured to align with two or more of the segment openings of the first plurality of segment openings to permit the two or more link openings and the two or more segment openings of the first plurality of segment openings to receive fasteners to prevent rotation of the first segment relative to the pivoting link; and
one of the link openings is configured to align with one of the segment openings of the second plurality of segment openings to permit the one link opening and the one segment opening of the second plurality of segment openings to receive a fastener to permit the second segment to rotate relative to the pivoting link.

3. The cable management system of claim 1, wherein:
the first segment comprises a first sidewall;
the second segment comprises a second sidewall; and
the pivoting link is configured to:
couple to the first sidewall to prevent rotation of the first segment relative to the pivoting link; and
couple to the second sidewall to form the articulating joint configured to permit the second segment to rotate relative to the pivoting link.

4. The cable management system of claim 1, wherein the first segment comprises:
a first channel portion;
a second channel portion configured to couple to the first channel portion; and
a cover configured to engage the first channel portion and the second channel portion, wherein the first channel portion, the second channel portion, and the cover define the first volume.

5. The cable management system of claim 4, wherein:
the first channel portion comprises a first sidewall; and
the first sidewall is configured to engage the cover to limit deflection of the cover.

6. The cable management system of claim 5, wherein the second channel portion comprises a second sidewall configured to couple to the first sidewall such that the first sidewall and the second sidewall bisect the first volume to define a plurality of sub-volumes, each sub-volume of the plurality of sub-volumes configured to receive the cable.

7. The cable management system of claim 5, wherein the first channel portion comprises a single piece of material.

8. The cable management system of claim 1, wherein the first segment comprises
a first channel portion comprising a first sidewall, the first sidewall comprising a first protrusion;
a second channel portion comprising a second sidewall configured to couple to the first sidewall, the second sidewall comprising a second protrusion; and
a cover configured to engage the first sidewall and the second sidewall, the cover defining a cover opening configured to receive the first protrusion and the second protrusion.

9. The cable management system of claim 8, wherein:
the first protrusion and the second protrusion define a plurality of fastener openings; and
the second sidewall is configured to couple to the first sidewall such that the fastener openings are generally aligned to permit a fastener to pass through the plurality of fastener openings to couple the cover to the first channel portion and the second channel portion.

10. The cable management system of claim 9, wherein the first protrusion and the second protrusion extend beyond a top surface of the cover when the cover opening receives the first protrusion and the second protrusion such that the fastener openings are proximate the top surface of the cover.

11. The cable management system of claim 1, wherein the first segment comprises a top surface and the first segment is configured to permit a vehicle to traverse the top surface.

12. The cable management system of claim 1, wherein the first segment defines an anchor opening configured to interface with an anchor fastener to secure the first segment to an uneven installation surface and prevent the first segment from moving relative to the uneven installation surface.

13. The cable management system of claim 1, wherein the first segment comprises:
a first channel portion comprising a first ramp portion comprising a first top surface;
a second channel portion comprising a second ramp portion comprising a second top surface; and
a cover configured to engage the first channel portion and the second channel portion, the cover comprising a third top surface, wherein the first ramp portion, the second ramp portion, and the cover are configured to permit a vehicle to traverse the first top surface, the second top surface, and the third top surface.

14. A cable management system comprising:
a first segment comprising:
a first plurality of channel portions; and
a first cover configured to engage the first plurality of channel portions to define a first volume comprising a first plurality of sub-volumes, each sub-volume of the first plurality of sub-volumes configured to receive a cable;
a second segment comprising:
a second plurality of channel portions; and
a second cover configured to engage the second plurality of channel portions to define a second volume comprising a second plurality of sub-volumes, each sub-volume of the second plurality of sub-volumes configured to receive the cable; and
a pivoting link configured to couple to a channel portion of the first plurality of channel portions to prevent rotation of the first segment relative to the pivoting link and configured to couple to a channel portion of the second plurality of channel portions to form an articulating joint configured to permit the second segment to rotate relative to the pivoting link.

15. The cable management system of claim 14, wherein:
the channel portion of the first plurality of channel portions defines a first plurality of segment openings;
the channel portion of the second plurality of channel portions defines a second plurality of segment openings;
the pivoting link defines a plurality of link openings;
two or more of the link openings are configured to align with two or more of the segment openings of the first plurality of segment openings to permit the two or more link openings and the two or more segment openings of the first plurality of segment openings to receive fasteners to prevent rotation of the first segment relative to the pivoting link; and
one of the link openings is configured to align with one of the segment openings of the second plurality of segment openings to permit the one link opening and the one segment opening of the second plurality of segment openings to receive a fastener to permit the second segment to rotate relative to the pivoting link.

16. The cable management system of claim 14, wherein the first plurality of channel portions comprises:
a first channel portion configured to couple to the pivoting link, the first channel portion comprising a first ramp portion comprising a first top surface;
a second channel portion configured to couple to the first channel portion; and
a third channel portion configured to couple to the second channel portion, the third channel portion comprising a second ramp portion comprising a second top surface, wherein:
the first cover comprises a third top surface; and
the first ramp portion, the second ramp portion, and the first cover are configured to permit a vehicle to traverse the first top surface, the second top surface, and the third top surface.

17. The cable management system of claim 14, wherein the second segment is configured to rotate relative to the pivoting link to permit the cable management system to contour to an uneven installation surface.

18. The cable management system of claim 14, wherein:
the first plurality of channel portions comprises a first plurality of sidewalls configured to engage the first cover to limit deflection of the first cover; and
the second plurality of channel portions comprises a second plurality of sidewalls configured to engage the second cover to limit deflection of the second cover.

19. The cable management system of claim 18, wherein:
the first plurality of sidewalls comprises a plurality of protrusions; and
the first cover defines a plurality of cover openings, each of the cover openings configured to receive a protrusion; and
the plurality of protrusions extend beyond a top surface of the first cover when the cover openings receive the protrusion.

20. The cable management system of claim 14, wherein the first plurality of channel portions comprises:
a first channel portion that defines a first anchor opening;
a second channel portion configured to couple to the first channel portion; and
a third channel portion configured to couple to the second channel portion, the third channel portion defining a second anchor opening, wherein the first anchor opening and the second anchor opening are configured to interface with anchor fasteners to secure the first segment to an uneven installation surface and prevent the first segment from moving relative to the uneven installation surface.
